(19) United States
(12) Patent Application Publication
(10) Pub. No.: US 2005/0238109 A1
(43) Pub. Date: Oct. 27, 2005

(54) Communication apparatus and communication method using digital wavelet multi carrier transmission system

(75) Inventors: Hisao Koga, Chikushi-gun (JP); Nobutaka Kodama, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/105,582

(22) Filed: Apr. 14, 2005

(30) Foreign Application Priority Data
Apr. 16, 2004 (JP) P. 2004-121457

(51) Int. Cl. H04B 1/38

(52) U.S. Cl. 375/260

(57) ABSTRACT

When a pilot carrier is provided in data transmission according to the DWMC transmission system, continuous identical data are given in a sub-carrier pair having predetermined adjacent two sub-carriers as a unit in plural sub-carriers on a frequency axis, whereby pilot carriers P1, P2, . . . to be sine wave signals are formed. It is possible to perform clock shift compensation or the like between a transmitter and a receiver according to complex information obtained from the pilot carriers by transmitting a transmission signal using the pilot carriers between the transmitter and the receiver.

### BACKGROUND OF THE INVENTION

The present invention relates to a communication apparatus of a multi-carrier transmission system, and in particular to a communication apparatus and a communication method that use a multi-carrier transmission method for performing data transmission according to digital modulation and demodulation processing using a real coefficient wavelet filter bank (Digital Wavelet Multi Carrier transmission method, hereinafter referred to as “DWMC transmission method”).

In a terrestrial digital broadcast system and the like, data transmission in a broad band is made possible by a multi-carrier transmission system using OFDM (Orthogonal Frequency Division Multiplexing). As this type of data transmission method according to the multi-carrier transmission system using the OFDM, there is proposed a multi-carrier transmission method according to digital modulation and demodulation processing using a real coefficient wavelet filter bank (DWMC transmission method). In the DWMC transmission method, plural digital modulated waves are compounded by a real coefficient filter bank to generate a transmission signal. PAM (Pulse Amplitude Modulation) or the like is used as a modulation system for respective carriers.

The data transmission by the DWMC transmission method will be explained with reference to FIGS. 24 to 27. FIG. 24 is a diagram showing an example of a wavelet waveform. FIG. 25 is a diagram showing an example of a transmission waveform in the DWMC transmission method. FIG. 26 is a diagram showing a transmission spectrum in the DWMC transmission method. FIG. 27 is a diagram showing an example of a structure of a transmission frame in the DWMC transmission method.

In the data transmission by the DWMC transmission method, as shown in FIG. 24, impulse responses of respective sub-carriers are transmitted while overlapping each other in the respective sub-carriers. As shown in FIG. 25, respective transmission symbols are time waveforms in which the impulse responses of the respective sub-carriers are compounded. FIG. 26 shows an example of an amplitude spectrum. In the DWMC transmission method, about several tens to several hundreds transmission symbols in FIG. 25 are collected to form one transmission frame. FIG. 27 shows an example of a structure of a DWMC transmission frame. This DWMC transmission frame includes a symbol for frame synchronization, a symbol for equalization, and the like other than a symbol for information transmission.

FIG. 28 is a block diagram showing a conceptual structure of a communication apparatus in a conventional example including a transmitter 299 and a receiver 199 in the case in which the DWMC transmission method is adopted.

In FIG. 28, the receiver 199 includes an A/D converter 110 that performs analog-digital conversion, a wavelet transformer 120 that performs discrete wavelet transformation, a parallel/serial converter (P/S converter) 130 that converts parallel data into serial data, and a determiner 140 that determines a reception signal. The transmitter 299 includes a symbol mapper 210 that converts bit data into symbol data and performs symbol mapping, a serial/parallel converter (S/P converter) 220 that converts serial data into parallel data, an inverse wavelet transformer 230 that performs inverse discrete wavelet transformation, and a D/A converter 240 that performs digital-analog conversion.

An operation of the communication apparatus having the structure described above will be explained. First, in the transmitter 299, bit data of transmission data is converted into symbol data by the symbol mapper 210 to perform symbol mapping (PAM) in accordance with the respective symbol data. Then, serial data is converted into parallel data by the S/P converter 220 to give a real number value di (i=1 to M, M is two or more) to the symbol data for each sub-carrier. Thereafter, this real number value is subjected to inverse discrete wavelet transformation to be converted into a value on a time axis by the inverse wavelet transformer 230. Consequently, a sample value of a time axis waveform is generated to create a sample value sequence representing a transmission symbol. This sample value sequence is converted into an analog base band signal waveform, which continues temporally, by the D/A converter 240 to transmit the analog base band signal. Here, the number of sample values on the time axis generated by the inverse discrete wavelet transformation is usually nth power of 2 (n is a positive integer).

In the receiver 199, analog base band signal waveform obtained from a reception signal is sampled by the A/D converter 110 at the same sample rate as the transmission side to obtain a sample value sequence. Then, the sample value sequence is subjected to discrete wavelet transformation to be converted into a value on a frequency axis by the wavelet transformer 20. Parallel data is converted into serial data by the P/S converter 130. Finally, amplitude values of the respective sub-carriers are calculated in the determiner 140 to determine the reception signal and obtain reception data.

As an example of the communication apparatus using the DWMC transmission method, there is proposed a power-line carrier communication apparatus that uses a power line laid at home or the like as a communication medium to perform data transmission (for example, see, JP-A-2003-218831).

Incidentally, in the multi-carrier transmission system, in order to perform adjustment or the like of a phase of transmission data, a pilot carrier, which transmits a pilot signal based on a signal of a sine wave in a predetermined carrier, may be provided. It is possible to adjust a phase of transmission data and compensate for clock shift or the like between a transmitter and a receiver.

As a pilot carrier in the conventional multi-carrier transmission system according to the OFDM on an FFT (Fast Fourier Transform) basis, for example, three is one defined in the IEEE 802.11a standard (see document “Part 11: Wireless LAN Medium Access Control (MAC) and Physical Layer (PHY) specifications: High-speed Physical Layer in the 5 GHZ Band”, IEEE Std 802.11a-1999, (United States), The Institute of Electrical and Electronics Engineers, Inc., Dec. 30, 1999, p. 22 to 25). Such a multi-carrier transmission system according to the OFDM on an FFT basis performs FFT that is complex number conversion. Thus, when a pilot carrier is provided, it is possible to generate a pilot carrier having complex information representing an amplitude and a phase simply by transmitting a known signal (e.g., a signal in which identical data such as all 1 continues) using one carrier. On the other hand, the multi-carrier transmission system according to the OFDM on a wavelet transformation basis used in the DWMC transmission method performs wavelet transformation that is real number conversion. Thus, it is impossible to generate a pilot carrier having complex information simply with one carrier.

### SUMMARY OF THE INVENTION

The invention has been devised in view of the circumstances described above and it is an object of the invention to provide a communication apparatus and a communication method of a multi-carrier transmission system capable of using a pilot carrier, which can handle complex information, in data transmission of a multi-carrier transmission system according to OFDM on a wavelet transformation basis for performing real coefficient conversion.

According to the present invention, a communication apparatus of a multi-carrier transmission system that performs data transmission according to digital modulation and demodulation processing, comprises: modulator which performs digital multi-carrier modulation processing for a transmission signal including a pilot carrier by use of a filter bank subjecting wavelet transformation, the pilot carrier being formed by giving continuous identical data to at least one of adjacent two sub-carriers; and transmitter for transmitting transmission signal, which has been subjected the digital multi carrier modulation processing by said modulator.

Further, according to the present invention, a communication apparatus of a multi carrier transmission system that performs data transmission according to digital modulation and demodulation processing, comprises: receiver for receiving transmission signal including a pilot carrier being formed by giving contiguous identical data to at least one of adjacent two sub-carriers; and demodulator which performs digital multi carrier demodulation processing for transmission signal received by said receiver with use of a filter bank subjecting wavelet transformation.

This, it is possible to use a pilot carrier, which can handle complex information, in data transmission of a multi-carrier transmission system according to OFDM on a wavelet transformation basis for performing real coefficient wavelet transformation.

### BRIEF DESCRIPTION OF THE DRAWINGS

FIGS. 1A and 1B are block diagrams showing a main structure of a communication apparatus according to a first embodiment of the invention.

FIG. 2 is a diagram schematically showing a carrier structure on a frequency axis in the first embodiment.

FIG. 3 is a diagram showing a pilot carrier on a frequency axis in the first embodiment.

FIG. 4 is a diagram showing a pilot carrier in a multi-carrier transmission system according to OFDM on an FFT basis.

FIG. 5 is a block diagram showing a first example of a wavelet transformer 22 in a receiver in this embodiment.

FIG. 6 is a block diagram showing a structure of a clock shift compensator in the receiver in this embodiment.

FIG. 7 is a diagram showing an example of a signal point on an orthogonal plane of a reception signal in this embodiment.

FIG. 8 is a block diagram showing a second example of the wavelet transformer in the receiver in this embodiment.

FIG. 9 is a diagram schematically showing a carrier structure on a frequency axis in a second embodiment of the invention.

FIG. 10 is a diagram showing a pilot carrier on a frequency axis in the second embodiment.

FIG. 11 is a diagram schematically showing a carrier structure on a frequency axis in a third embodiment of the invention.

FIG. 12 is a diagram showing a pilot carrier on a frequency axis in the second embodiment.

FIG. 13 is a block diagram showing a main structure of a receiver according to a fourth embodiment of the invention.

FIG. 14 is a characteristic chart showing an example of a relation between CINR information for each sub-carrier obtained by a channel estimator and a pilot carrier in the fourth embodiment.

FIG. 15 is a block diagram showing a main structure of a receiver according to a fifth embodiment of the invention.

FIG. 16 is a block diagram showing a main structure of a receiver according to a sixth embodiment of the invention.

FIG. 17 is a characteristic chart showing an example of a relation between amplitude information for each sub-carrier obtained by a channel equalizer and a pilot carrier in the sixth embodiment.

FIG. 18 is a block diagram showing a main structure of a receiver according to a seventh embodiment of the invention.

FIG. 19 is a block diagram showing a main structure of a receiver according to an eighth embodiment of the invention.

FIG. 20 is a diagram schematically showing respective sub-carriers on a frequency axis in the eighth embodiment.

FIG. 21 is a characteristic chart showing an example of a phase difference between a sub-carrier pair in the eighth embodiment.

FIG. 22 is a block diagram showing a main structure of a receiver according to a ninth embodiment of the invention.

FIG. 23 is a characteristic chart showing an example of a relation between CINR information for each sub-carrier obtained from a channel estimator and a pilot carrier in the ninth embodiment.

FIG. 24 is a diagram showing an example of a wavelet waveform.

FIG. 25 is a diagram showing an example of a transmission waveform in a DWMC transmission method.

FIG. 26 is a diagram showing a transmission spectrum in the DWMC transmission method.

FIG. 27 is a diagram showing an example of a structure of a transmission frame in the DWMC transmission method.

FIG. 28 is a block diagram showing a conceptual structure of a communication apparatus in a conventional example including a transmitter and a receiver in the case in which the DWMC transmission method is adopted.

FIG. 29 is an external appearance perspective view which shows a communication apparatus (front surface).

FIG. 30 is an external appearance perspective view which shows the communication apparatus (rear surface).

FIGS. 31A and 31B are block diagrams which shows a modified example of a configuration of a communication apparatus which uses a power line as a transmission path.

FIG. 32 is a diagram showing a pilot carrier on a frequency axis in the first embodiment, the continuous identical data are given to lower one of the sub-carrier pair including the adjacent two sub-carriers.

### DETAILED DESCRIPTION OF THE PREFERRED EMBODIMENTS

In embodiments of the invention, a structure and an operation of a communication apparatus, which performs data transmission with a multi-carrier transmission method (a DWMC transmission method) according to digital modulation and demodulation processing using a real coefficient wavelet filter bank, will be explained.

### First Embodiment

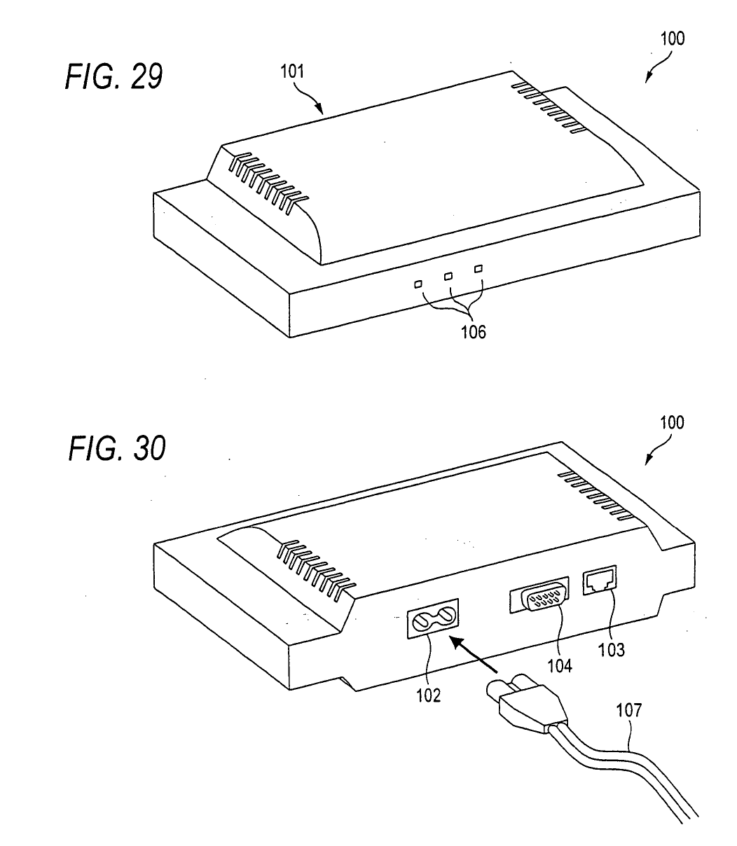

FIG. 29 is an external appearance perspective view which shows a communication apparatus (front surface), and FIG. 30 is an external appearance perspective view which shows the communication apparatus (rear surface). A communication apparatus 100 in this embodiment is a modem as shown in FIGS. 29 and 30. This communication apparatus 100 is one which configures a transmitting device 70 or a receiving device 80 which will be described later.

The communication apparatus 100 has a housing 101. On a front surface of the housing 101, a display section 106 such as LED (Light Emitting Device) is disposed as shown in FIG. 29. On a rear surface of the housing 101, a power connector 102, a LAN (Local Area Network) modular jack 103 such as RJ45, and a Dsub connector 104 are disposed as shown in FIG. 30. To the power connector 102, a power line 107 such as a parallel cable is connected as shown in FIG. 30. To the modular jack 103, a LAN cable, which is not shown in the figure, is connected. To the Dsub connector 104, a Dsub cable, which is not shown in the figure, is connected.

To the power line 107, a commercial power source such as alternating voltage is applied, and when a pilot symbol, which will be described later, is outputted, the pilot symbol is overlapped with the alternating voltage through a coupler transformer which is not shown in the figure. Meanwhile, as one example of the communication apparatus, the modem in FIGS. 29 and 30 was shown, but there is no particular need to limit to this, and the communication apparatus may be an electric equipment which was equipped with a modem (e.g., a household electrical appliance such as a television receiver).

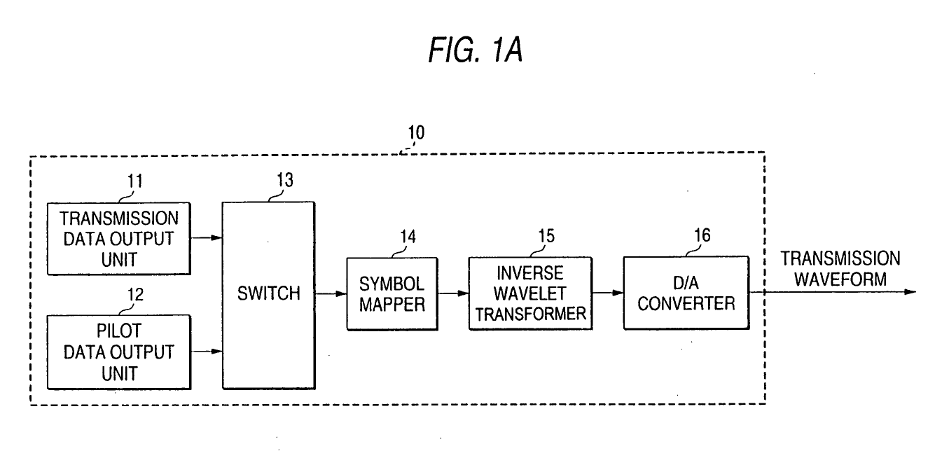

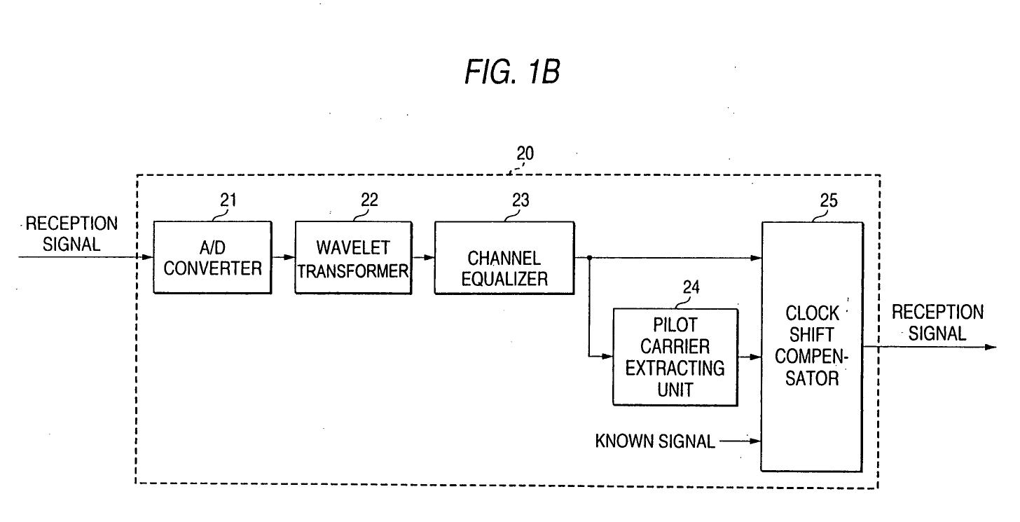

FIGS. 1A and 1B are block diagrams showing a main structure of a communication apparatus according to a first embodiment of the invention. FIG. 1A is a block diagram showing a transmitter constituting the communication apparatus and FIG. 1B is a block diagram showing a receiver constituting the communication apparatus. The transmitter 10 includes a transmission data output unit 11 that outputs transmission data, a pilot data output unit 12 that outputs pilot data for a pilot signal, a switch 13 that performs switching selection of the transmission data or the pilot data, a symbol mapper 14 that converts bit data into symbol data to perform symbol mapping, an inverse wavelet transformer 15 that performs inverse discrete wavelet transformation, and a D/A converter 16 that performs digital-analog conversion.

Meanwhile, the transmission data output section 11, the pilot data output section 12, the switch 13, the symbol mapper 14, and the inverse wavelet transformer 15 are configured by a MAC/PHY-IC chip (not shown in the figure) which carries out management of a MAC (Media Access Control) level and a PHY (Physical) layer. The D/A converter 16 is configured by an AFE (Analog Front End) IC chip (not shown in the figure).

The receiver 20 includes an A/D converter 21 that performs analog-digital conversion, a wavelet transformer 22 that performs discrete wavelet transformation, a channel equalizer 23 that performs equalization of a channel characteristic (compensation for a transmission characteristic, etc.) between the transmitter 10 and the receiver 20, a pilot carrier extracting unit 24 that extracts a pilot carrier from a reception signal, and a clock shift compensator 25 that compensates for clock shift of the reception signal using the pilot carrier.

Meanwhile, the wavelet transformer 22, the pilot symbol extraction section 23, the channel frequency characteristic estimator 24, and the channel equalizer 25 are configured by a MAC/PHY-IC chip (not shown in the figure) which carries out management of a MAC (Media Access Control) level and a PHY (Physical) layer. The A/D converter 21 is configured by an AFE (Analog Front End) IC chip (not shown in the figure).

In the transmitter 10, when transmission data is outputted, the transmission data output unit 11 is connected to the symbol mapper 14 according to switching selection by the switch 13. At this point, bit data of arbitrary transmission data outputted from the transmission data output unit 11 is converted into symbol data by the symbol mapper 14 to perform symbol mapping (PAM) in accordance with the respective symbol data. Thereafter, serial data is converted into parallel data by the inverse wavelet transformer 15 to give a real number value di (i=1 to M, M is two or more) to the symbol data for each sub-carrier and, then, data of this real number value is subjected to inverse discrete wavelet transformation to be converted into a value on a time axis. Consequently, a sample value of a time axis waveform is generated to create a sample value sequence representing a transmission symbol. A filter bank subjecting a wavelet transformation using a rear coefficient will be referred as a real coefficient wavelet filter bank, hereinafter. Then, this sample value sequence is converted into an analog base band signal waveform, which is continuous temporally, and transmitted.

When a pilot carrier is outputted, the pilot data output unit 12 is connected to the symbol mapper 14 according to switching selection by the switch 13. At this point, bit data of pilot data outputted from the pilot data output unit 12 is converted into symbol data by the symbol mapper 14. Then, serial data is converted into parallel data by the inverse wavelet transformer 15 to give continuous identical data (e.g., all 1, all 0, etc.) to a corresponding sub-carrier as symbol data and this data is subjected to inverse discrete wavelet transformation to be converted into a value on a time axis. Thereafter, the parallel data is converted into an analog base band signal waveform including a pilot carrier by the D/A converter 16 and transmitted. The contiguous identical data is a data series which corresponds to each symbol and is configured by consecutive identical values (e.g., 0 or 1), and for example, contiguous identical data, which corresponds to 1 symbol, is configured by all 1 (1, 1, 1, . . . , 1), and contiguous identical data, which corresponds to 2 symbol, is configured by all 0 (0, 0, 0, . . . , 0), and contiguous identical data, which corresponds to K symbol, is configured by all 1 (1, 1, 1, . . . , 1).

In the transmitter 10, the inverse wavelet transformer 15 has a function of modulator. The pilot data output unit 12 and the switch 13 have a function of pilot carrier generator.

In the receiver 20, the analog base band signal waveform obtained from the reception signal by the A/D converter 21 is sampled at the same sample rate as the transmission side to obtain a sample value sequence. The sample value sequence is subjected to discrete wavelet transformation to be converted into a value on a frequency axis by the wavelet transformer 22 and, after obtaining complex information included in the reception signal, parallel data is converted into serial data. Next, an amount of equalization for performing, for example, compensation for a transmission characteristic of a channel for each sub-carrier is calculated by the channel equalizer 23 using this complex information to perform equalization of the reception signal. Thereafter, a pilot carrier is extracted from the reception signal by the pilot carrier extracting unit 24. Clock shift compensation for the reception signal is performed in the clock shift compensator 25 using this pilot carrier and a known signal. This clock shift compensation processing will be described later.

In the receiver 20, the wavelet transformer 22 has a function of demodulator. The pilot carrier extracting unit 24 has a function of pilot carrier extractor. The clock shift compensator 25 has a function of clock shift compensator.

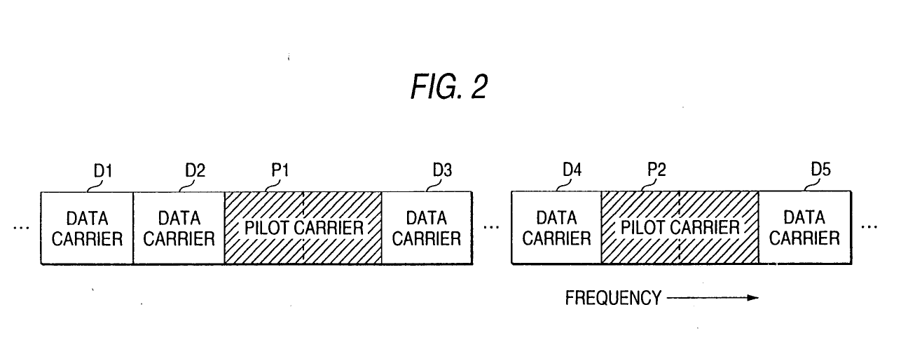

Next, generation of a pilot carrier according to this embodiment will be explained. FIG. 2 is a diagram schematically showing a carrier structure on a frequency axis in the first embodiment. In a multi-carrier transmission system according to OFDM, a large number of sub-carriers with different frequencies are generated, transmission data is included in the respective plural sub-carriers divided on the frequency axis, and data communication is performed in a form in which plural carriers are multiplexed. In this embodiment, when a pilot carrier is provided in data transmission according to the DWMC transmission method, a pilot carrier to be a sine wave signal is generated by giving continuous identical data (e.g., all 1, all 0, etc.) in a sub-carrier pair having adjacent two sub-carriers as a unit, that is, plural (multiple of 2 (even number), two in the example in FIG. 2) sub-carriers.

In FIG. 2, when data carriers D1, D2, D3, . . . are set in plural carriers on the frequency axis, continuous identical data are given in a sub-carrier pair formed by predetermined adjacent two sub-carriers to form pilot carriers P1, P2, . . . . The pilot carriers make it possible to realize pilot carriers, which can handle complex information, in the multi-carrier transmission system according to OFDM on a wavelet transformation basis for handling real number information in the same manner as the conventional multi-carrier transmission system according to OFDM on an FFT basis.

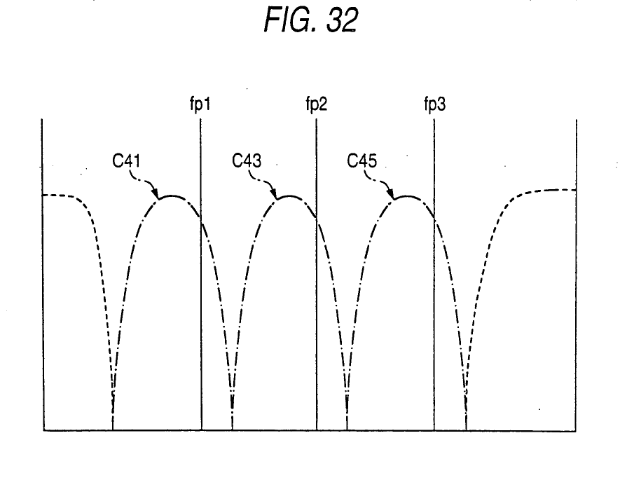

In the above, shown is an example in that continuous identical data are given in the sub-carrier pair formed by the adjacent two sub-carriers. However, the present invention is not limited thereto, if the continuous identical data are given in at least one of the sub-carrier pair including the adjacent two sub-carrier. For example, in the case of a plurality of sub-carriers C41, C42, C43, C44, C45, C46, C47, C48, C49, C50, . . . are continuously set in the frequency axis, the continuous identical data may be given to the sub-carriers at lower frequency side in the sub-carrier pairs. That is, the continuous identical data are given to the sub-carriers C41, C43, C45, C47, C49, . . . regularly, as shown FIG. 32. Contrary, the continuous identical data may be given to the sub-carrier randomly selected in the sub-carrier pairs. That is, the continuous identical data are given to the sub-carriers C42, C43, C45, C48, C49 . . .

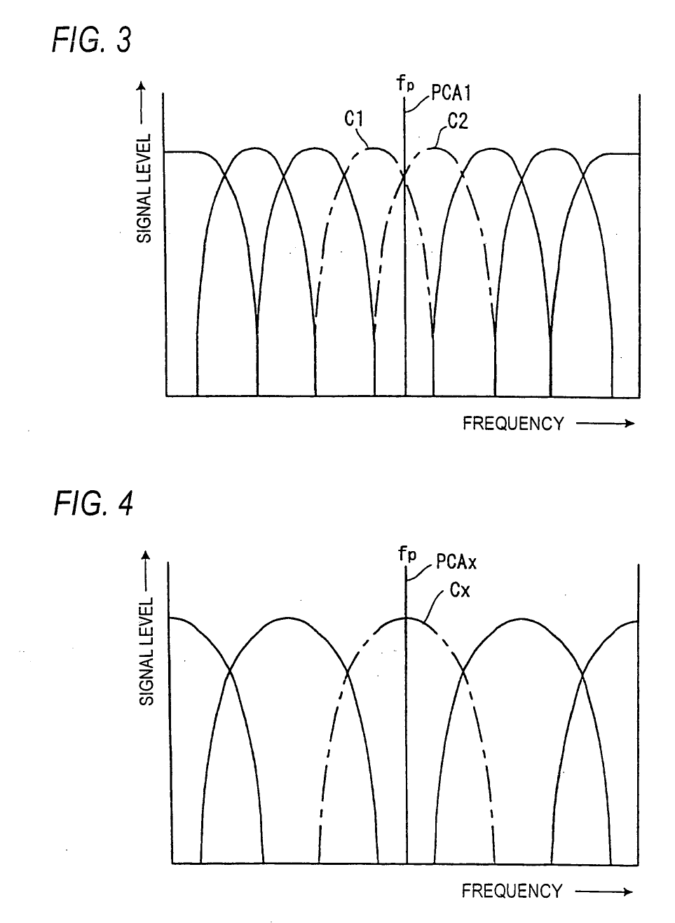

FIG. 3 is a diagram showing a pilot carrier on a frequency axis in the first embodiment. FIG. 4 is a diagram showing a pilot carrier in the multi-carrier transmission system according to OFDM on an FFT basis. FIG. 3 shows sub-carriers in the case in which the sub-carriers are applied to the multi-carrier transmission system according to OFDM on an eight-point wavelet transformation basis as an example of this embodiment. FIG. 4 shows sub-carriers in the case in which the sub-carriers are applied to the multi-carrier transmission system according to OFDM on an FFT basis under the same conditions as FIG. 3 as a comparative example. Note that a side lobe is not shown for simplification. In the OFDM, signals of adjacent sub-carriers are in an orthogonal relation with each other and it is possible to acquire signals of the respective sub-carriers independently. In particular, in the OFDM on a wavelet transformation basis, since a level of a side lob is small, influence of a sub-carrier to sub-carriers around the sub-carrier is small and interference among carriers is reduced.

In this embodiment, as shown in FIG. 3, in eight sub-carriers, continuous identical data are given to a sub-carrier pair formed by adjacent two sub-carriers C1 and C2a, whereby sine wave pilot carrier PCA1 having an intermediate frequency fp of the sub-carriers C1 and C2 is generated. Note that, in the sub-carriers C1 and C2, it is not always necessary to give identical data among carriers. It is possible generate a sine wave pilot carrier if continuous identical data are given in the respective carriers. It is possible to change a phase of a pilot carrier by appropriately changing data to be given in two sub-carriers, respectively.

On the other hand, in the case of the multi-carrier transmission system according to OFDM on an FFT basis, as shown in FIG. 4, continuous identical data are given to one sub-carrier Cx, whereby a sine wave pilot carrier PCAx having a center frequency fp of this sub-carrier Cx is generated.

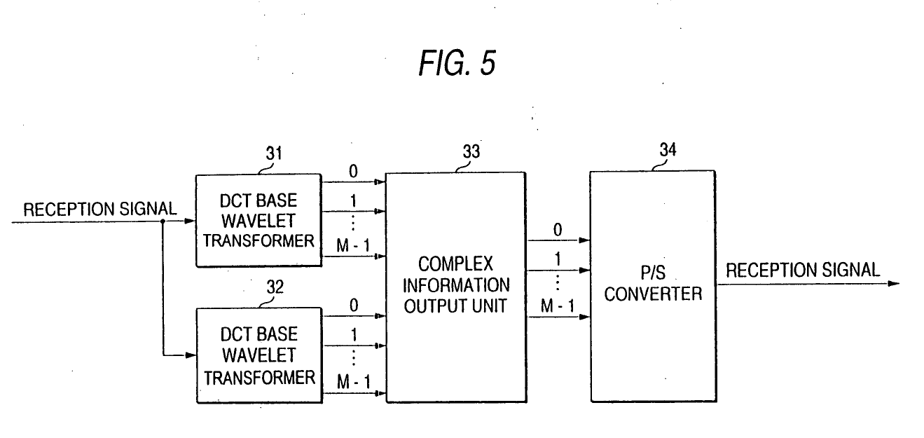

Next, a structure and an operation of a wavelet transformer in the receiver in this embodiment will be explained. FIG. 5 is a block diagram showing a first example of the wavelet transformer 22 in the receiver 20. The wavelet transformer 22 in the first example includes a DCT base wavelet transformer 31 that applies wavelet transformation on a DCT (discrete cosine transformation) basis using a real coefficient wavelet filter bank to a reception signal, a DST base wavelet transformer 32 that applies wavelet transformation on a DST (discrete sine transformation) basis using a real coefficient wavelet filter bank to the reception signal, a complex information output unit 33 that outputs complex information of the reception signal on the basis of outputs of the DCT base wavelet transformer 31 and the DST base wavelet transformer 32, and a parallel/serial converter (P/S converter) 34 that converts parallel data into serial data.

In the structure described above, wavelet transformation on a DCT basis is performed by the DCT base wavelet transformer 31 for each sub-carrier of a reception signal converted into a digital signal, whereby a first signal used as an in-phase signal is obtained. In addition, wavelet transformation on a DST basis is performed by the DST base wavelet transformer 32, whereby a second signal used as an orthogonal signal, which is orthogonal to the in-phase signal, is obtained. The in-phase signal and the orthogonal signal are outputted from the complex information output unit 33 as complex information on the basis of the first and the second signals. Complex information having amplitude information and phase information is obtained according to the in-phase signal and the orthogonal signal. Then, a parallel signal is converted into a serial signal by the P/S converter 34 and outputted.

In the receiver 20 having the wavelet transformer 22 with such a structure, when the pilot carrier PCA1 in this embodiment is received, a sine wave signal of a pilot carrier having an in-phase component and an orthogonal component is demodulated. It is possible to obtain complex information serving as a reference for clock shift compensation or the like according to a reception signal of this pilot carrier. A demodulation signal obtained by demodulating a sine wave is indicated by one signal point on an orthogonal plane formed by the in-phase component (I axis) and the orthogonal component (Q axis). Therefore, it is possible to compensate for clock shift or the like between the transmitter and the receiver on the basis of an amount of displacement of a phase on the orthogonal plane of the demodulation signal of the pilot carrier.

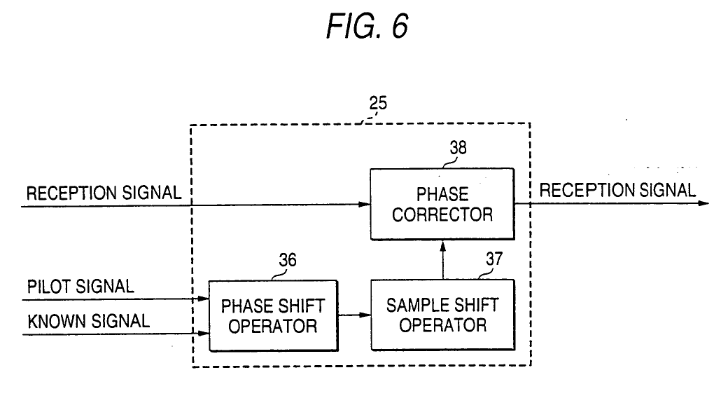

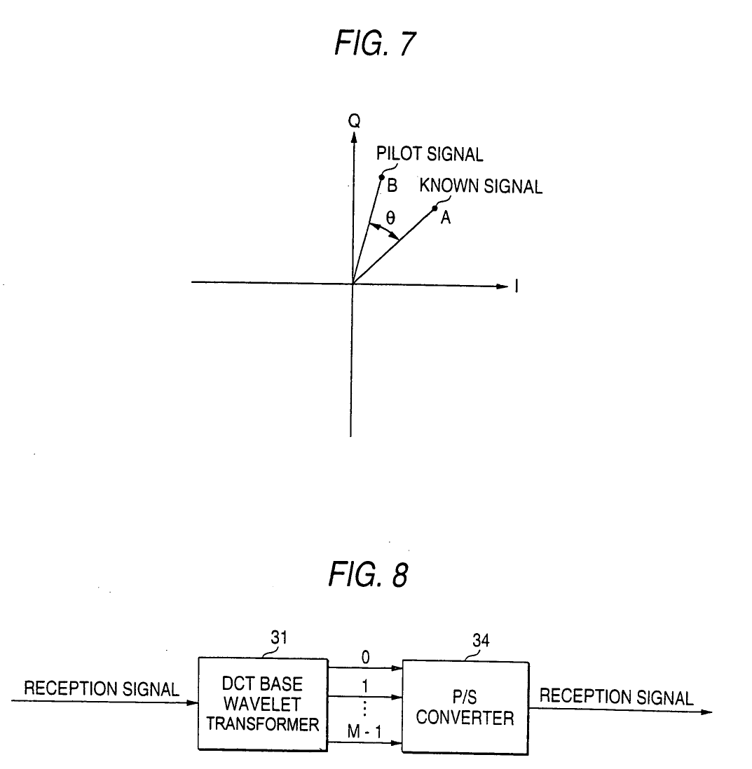

Next, a structure and an operation of a clock shift compensator in the receiver in this embodiment will be explained. FIG. 6 is a block diagram showing a structure of the clock shift compensator 25 in the receiver 20. FIG. 7 is a diagram showing an example of a signal point on an orthogonal plane of a reception signal. The clock shift compensator 25 includes a phase shift operator 36 that calculates phase shift between a pilot signal and a known signal in each sub-carrier, a sample shift operator 37 that calculates sample shift of a time signal from a frequency and phase shift of each sub-carrier, and a phase corrector 38 that performs phase correction for a reception signal using obtained sample shift information.

For example, as shown in FIG. 7, when a signal point A of a known signal used as a reference signal and a signal point B of a received pilot signal deviate from each other, an angle Θ at this point indicates an inclination of scatter due to clock shift, that is, phase shift due to clock shift between the transmitter and the receiver. In performing clock shift compensation, first, phase shift Δφ of the pilot signal with respect to the known signal is calculated by the phase shift operator 36 using a predetermined algorithm. Then, in the sample shift operator 37, sample shift τ of the time signal is calculated from the following expression using the phase shift Δφ of the pilot signal outputted from the phase shift operator 36 and the frequency fp of the pilot signal.
τ=Δφ/(2πfp) (1)

Note that, when plural (k) pilot carriers are used, sample shift τk of the respective pilot carriers is calculated.
τk=Δφk/(2πfpk) (2)

Then, the calculated sample shift τk is averaged by the pilot carriers in use, an average sample shift τavg from synchronous timing of the time signal is calculated. Thereafter, a phase φn of each sub-carrier is calculated from the calculated average sample shift τavg according to the following expression by the phase corrector 38 to correct phases of the respective sub-carriers of the reception signal.
φn=2πfn τavg (3)
n: sub-carrier number
fn: frequency of each sub-carrier

It is possible to compensate for the clock shift between the transmitter and the receiver using the pilot carrier according to the arithmetic operation processing described above. Data determination is applied to the reception signal after the clock shift compensation by a determiner to acquire reception data.

FIG. 8 is a block diagram showing a second example of the wavelet transformer 22 in the receiver 20. The wavelet transformer 22 of the second example includes a DCT base wavelet transformer 31 that applies wavelet transformation on a DCT (discrete cosine transformation) base using a real coefficient wavelet filter bank to a reception signal, and a parallel/serial converter (P/S converter) 34 that converts parallel data into serial data.

When only one real number type wavelet transformer is used in this way, it is possible to combine real number information in two sub-carriers to generate complex information by receiving the pilot carrier PCA1 in this embodiment. Therefore, it is possible to obtain complex information for clock shift compensation or the like on the reception side according to the pilot carrier in this embodiment. In this second example, it is possible to reduce the number of wavelet transformers to reduce a circuit size.

Note that, in the embodiment described above, the clock shift compensator is provided in the receiver. However, the clock shift compensator may be provided in the transmitter to perform clock shift compensation using information of a pilot carrier.

As described above, according to the first embodiment, it is possible to form and use a pilot carrier, which can handle complex information for clock shift compensation or the like, by a pilot carrier that is generated using a sub-carrier pair having adjacent two sub-carriers as a unit. It is also possible to decrease an error rate of a transmission signal by compensating for clock shift between the transmitter and the receiver using information of the pilot carrier. In addition, since multi-value modulation can be used in primary modulation, it is possible to improve transmission efficiency.

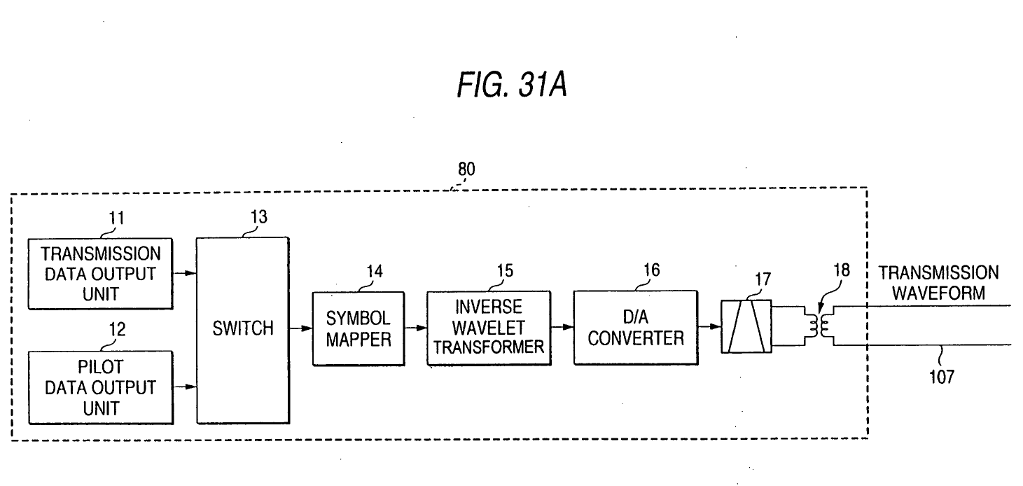

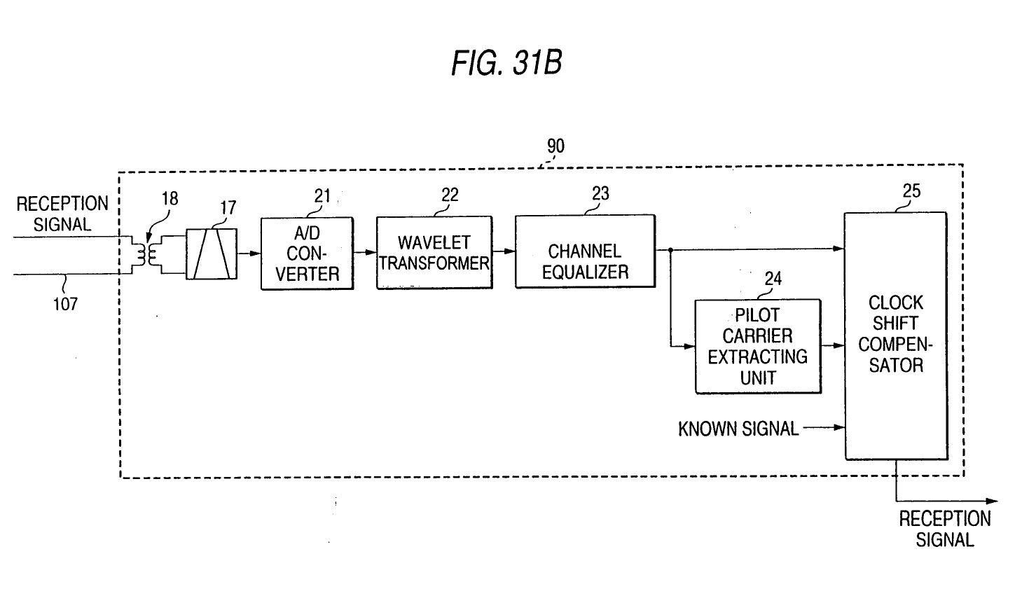

FIGS. 31A and 31B are block diagrams which shows a modified example of a configuration of a communication apparatus which uses a power line as a transmission path. Particularly, FIG. 31A shows a transmitting device, and FIG. 31B shows a receiving device. In the transmitting device and the receiving device shown in FIGS. 31A and 31B, identical reference numerals and signs are applied to identical elements to those of the transmitting device and the receiving device shown in FIGS. 1A and 1B, and thereby, explanations thereof will be omitted. A transmitting device 80 of FIG. 31A has BPF (Band Pass Filter) 17 and a coupler transformer 18, in addition to each element of the transmitting device of FIG. 1A. The coupler transformer 18 is connected to the power line 107. In addition, a receiving device 90 of FIG. 31B has BPF 26 and a coupler transformer 27, in addition to each element of the receiving device of FIG. 1B. The coupler transformer 27 is connected to the power line 107.

The transmission data output section 11, the pilot data output section 12, the switch 13, the symbol mapper 14, and the inverse wavelet transformer 15 are configured by a MAC/PHY-IC chip (not shown in the figure) which carries out management of a MAC (Media Access Control) level and a PHY (Physical) layer. The D/A converter 16 and BPF 17 are configured by an AFE (Analog Front End) IC chip (not shown in the figure).

In the transmitting device 80, when the D/A converter 16 outputs analog base band signal wave forms, BPF 17 gets through transmission wave forms in a predetermined frequency band. The coupler transformer 18 overlaps the transmission wave forms from BPF 17 with the alternating voltage, and transmits them through the power line 107. On one hand, in the receiving device 90, when signals, which were transmitted through the power line 107, have been received, the coupler transformer 27 separates the received signals from the alternating voltage, and BPF 26 gets through received signals in a predetermined frequency band. The A/D converter 21 samples analog base band signal wave forms which are obtained from the received signals, and will hereinafter carry out the same processing as that of the receiving device of FIG. 1B.

The wavelet transformer 22, the pilot symbol extraction section 23, the channel frequency characteristic estimator 24, and the channel equalizer 25 are configured by a MAC/PHY-IC chip (not shown in the figure) which carries out management of a MAC (Media Access Control) level and a PHY (Physical) layer. The A/D converter 21 and BPF 26 are configured by an AFE (Analog Front End) IC chip (not shown in the figure).

Meanwhile, in the transmitting device 80, the D/A converter 16, BPF 17, and the coupler transformer 18 are one which has a function of a transmission section. In the receiving device 90, the coupler transformer 27, BPF 26, and the A/D converter 21 are one which has a function of a receiving section.

### Second Embodiment

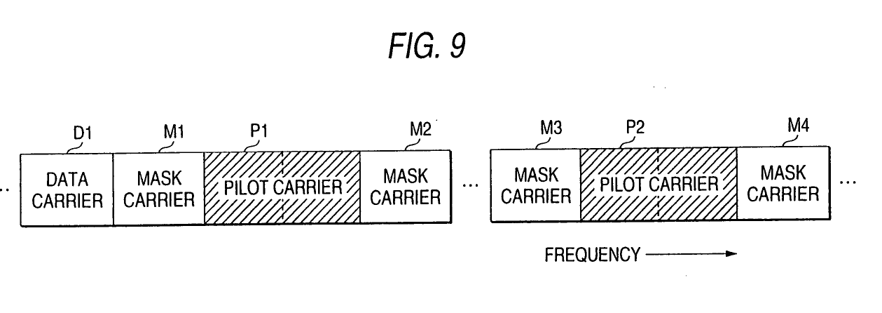

FIG. 9 is a diagram schematically showing a carrier structure on a frequency axis in a second embodiment of the invention. In the second embodiment, when a pilot carrier generated by using a sub-carrier pair having adjacent two sub-carriers as a unit is provided in data transmission according to the DWMC transmission method, one or more sub-carriers on both sides of the pilot carrier are not used as mask carriers.

In FIG. 9, when continuous identical data are given to a sub-carrier pair formed by predetermined adjacent two sub-carriers in plural sub-carriers on the frequency axis to form pilot carriers P1, P2, . . . , at least one (one each on both the sides in the example in FIG. 9) sub-carriers on both sides of the pilot carriers P1, P2, . . . are set as mask carriers M1, M2, . . . .

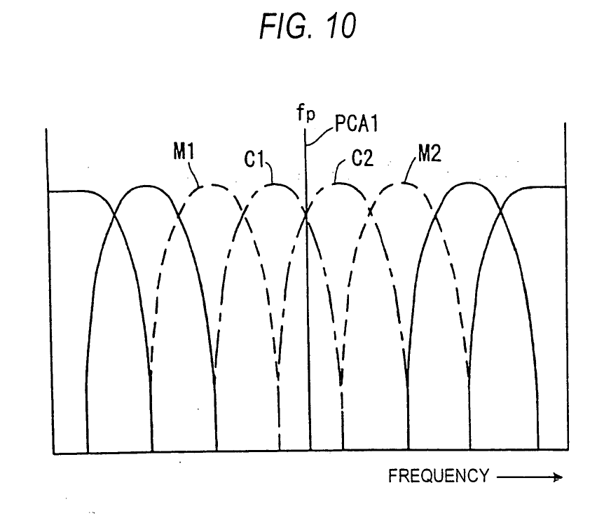

FIG. 10 is a diagram showing a pilot carrier on a frequency axis in the second embodiment. FIG. 10 shows sub-carriers in the case in which the sub-carriers are applied to the multi-carrier transmission system according to OFDM on an eight point wavelet transformation basis. Note that a side lobe is not shown for simplification. In this embodiment, as shown in FIG. 10, in eight sub-carriers, continuous identical data are given to a sub-carrier pair formed by adjacent two sub-carriers C1 and C2, whereby a sine wave pilot carrier PCA1 having an intermediate frequency fp of the sub-carriers C1 and C2 is generated. Note that, in the sub-carriers C1 and C2, it is not always necessary to give identical data. It is possible to generate a sine wave pilot carrier if continuous identical data are given in the respective carriers. In addition, the sub-carriers M1 and M2 on both sides of the two sub-carriers C1 and C2 forming the pilot carrier PCA1 are not used but are set as mask carriers.

In the second embodiment, since the mask carriers are provided as described above, even if orthogonality among sub-carriers is disturbed, it is possible to reduce influence from sub-carriers near the sub-carriers and reduce interference among carriers. Consequently, it is possible to improve accuracy of complex information obtained from a pilot carrier.

Note that, when a sub-carrier, in which a mask carrier is provided, is known in advance in a frequency band of a transmission signal, a pilot carrier may be provided next to this mask carrier. Consequently, it is possible to reduce the number of mask carriers provided on both sides of the pilot carrier in the entire band and increase the number of data carriers to improve efficiency of use of sub-carriers and improve transmission efficiency.

### Third Embodiment

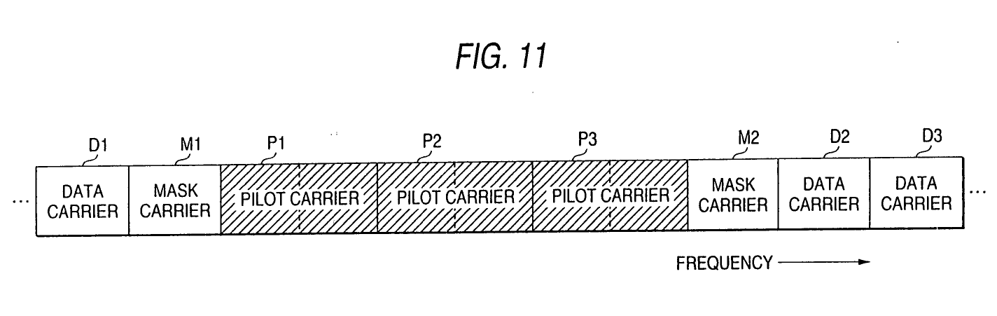

FIG. 11 is a diagram schematically showing a carrier structure on a frequency axis in a third embodiment of the invention. In the third embodiment, when a pilot carrier is provided in data transmission according to the DWMC transmission method, continuous identical data are given in plural sub-carrier pairs having adjacent two sub-carriers as a unit, that is, four or more continuous sub-carriers to generate a pilot carrier. In this case, continuous plural pilot carriers are set on the frequency axis.

In FIG. 11, when data carriers D1, D2, D3, . . . are set in plural sub-carriers on the frequency axis, continuous identical data are given to plural sub-carriers having predetermined adjacent two sub-carriers as a unit, that is, four or more (six in the example in FIG. 11) sub-carriers to form pilot carriers P1, P2, and P3. In addition, in the example in FIG. 11, as in the second embodiment, at least one (in the example in FIG. 11, one each on both sides) sub-carriers on both sides of the pilot carriers P1 to P3 are set as mask carriers M1 and M2.

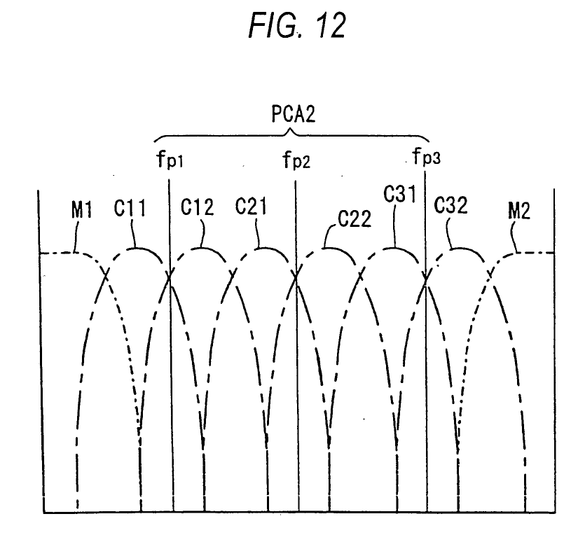

FIG. 12 is a diagram showing a pilot carrier on a frequency axis in the second embodiment. FIG. 12 shows sub-carriers in the case in which the sub-carriers are applied to the multi-carrier transmission system according to OFDM on an eight wavelet transformation basis. A side lobe is not shown for simplification. In this embodiment, as shown in FIG. 12, in eight sub-carriers, continuous identical data are given to continuous three sub-carrier pairs having adjacent two sub-carriers as a unit, that is, six sub-carriers C11, C12, C21, C22, C31, and C32, respectively, whereby a pilot carrier PCA2 including three sine waves, namely, a sine wave having an intermediate frequency fp1 of the sub-carriers C11 and C12, a sine wave having an intermediate frequency fp2 of the sub-carriers C21 and C22, and a sine wave having an intermediate frequency fp3 of the sub-carriers C31 and C32, is generated. Note that, in the sub-carriers CI1 to C32, it is not always necessary to give identical data. It is possible to generate a sine wave pilot carrier if continuous identical data are given in respective carriers. In addition, the sub-carriers M1 and M2 on both sides of the six sub-carriers C11 to C32 forming the pilot carrier PCA2 are not used but are set as mask carriers.

In the third embodiment, since a pilot carrier formed by continuous plural sine waves is provided as described above, the number of sine waves per a pilot carrier increases. Thus, it is possible to improve accuracy of complex information obtained from the pilot carrier. In addition, when the respective sine waves are used as pilot carriers, the pilot carriers are provided continuously, whereby it is possible to reduce the number of mask carriers when the mask carriers are provided on both sides of the pilot carriers.

When the three sine wave pilot carriers are provided on the frequency axis as described above, since the pilot carrier located in the center is not affected much by the sub-carriers near the pilot carrier, accuracy of complex information obtained from the pilot carriers is further improved. In this case, when clock shift compensation or the like is performed using the pilot carriers, the plural pilot carriers are weighted and weight of the pilot carrier in the center is set large, whereby compensation accuracy can be improved.

### Fourth Embodiment

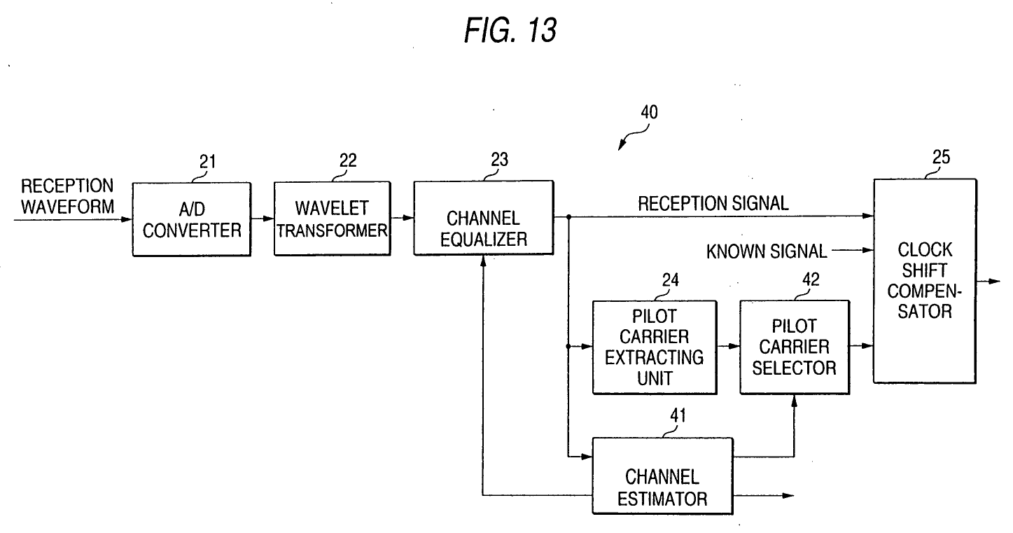

FIG. 13 is a block diagram showing a main structure of a receiver according to a fourth embodiment of the invention. The fourth embodiment is a first example in which pilot carrier selecting means is provided when plural pilot carriers are used. Note that components identical with those in the first embodiment are denoted by the identical reference numerals.

A receiver 40 in the fourth embodiment includes a channel estimator 41, which estimates a channel characteristic, and a pilot carrier selecting unit 42, which selects a pilot carrier according to an output of the channel estimator 41, together with the A/D converter 21, the wavelet transformer 22, the channel equalizer 23, the pilot carrier extracting unit 24, and the clock shift compensator 25. The pilot carrier selecting unit has a function of pilot carrier selector.

The channel estimator 41 detects a state such as a communication quality of a channel between a transmitter and a receiver. For example, the channel estimator 4 calculates a CINR (carrier power to interference and noise power ratio) in the channel. When a communication apparatus performing the DWMC transmission in this embodiment is applied to a power line communication system in which a power line at home is used for a transmission line, a transmission characteristic may vary depending on a frequency of a sub-carrier or fluctuation in a channel characteristic may be large depending on a location of installation because, for example, a wide frequency band is used in a multi-carrier and wiring, which is not used for communication originally, is used. Therefore, channel estimation between the transmitter and the receiver is performed for each sub-carrier to, for example, determine use/nonuse of a sub-carrier according to a channel characteristic and set a modulation system for primary modulation. This channel estimation is carried out by exchanging signals for estimation between the transmitter and the receiver.

CINR information obtained by the channel estimator 41 is used for, for example, determination of a modulation system at the time when a transmission signal is subjected to primary modulation in PAM or the like in the transmitter and the receiver. For example, when the CINR is large (there is little interference and noise for carriers and a channel state is satisfactory), a degree of modulation of the primary modulation is increased to perform multi-value modulation such as quadrature PAM, whereby a transmission rate is improved. On the other hand, when the CINR is small, since an error rate of a transmission signal increases, a degree of modulation of the primary modulation is lowered. Modulation system map data, in which a modulation system for the primary modulation is set and allocated for each of the sub-carriers, are held in both the transmitter and the receiver.

The pilot carrier selecting unit 42 selects a pilot carrier, which is used with a predetermined value of CINR as a threshold value, on the basis of the CINR information outputted from the channel estimator 41 among plural pilot carriers extracted by the pilot carrier extracting unit 24. In a sub-carrier with the CINR equal to or higher than the threshold value and a satisfactory channel state, it is considered that accuracy of complex information obtained from a pilot carrier of this sub-carrier is high and the pilot carrier has a satisfactory characteristic. This embodiment is an example in which it is assumed that plural pilot carriers are fixedly set. A pilot carrier of a sub-carrier having CINR equal to or higher than the threshold value is regarded as a pilot carrier appropriate for use as a reference signal and selected.

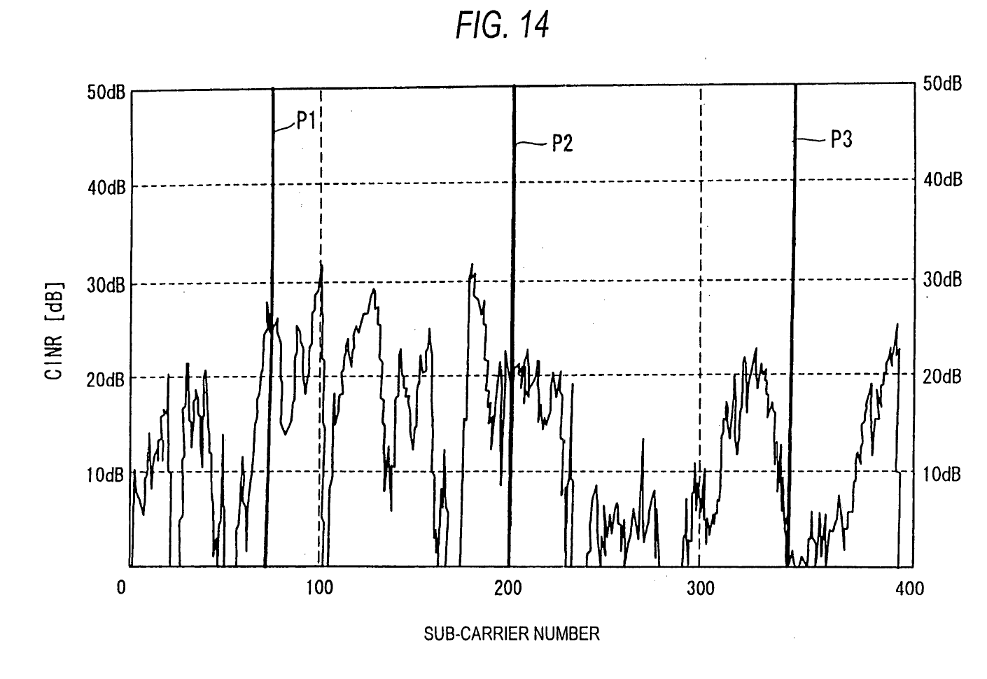

FIG. 14 is a characteristic chart showing an example of a relation between CINR information for each sub-carrier obtained by the channel estimator 41 and a pilot carrier. In FIG. 14, in sub-carriers from 1 to 390, three pilot carriers P1, P2, and P3 are fixedly set. In the pilot carrier selecting unit 42, for example, CINR=20 dB is set as a threshold value, and the pilot carriers P1 and P2 of a sub-carrier pair with the CINR equal to or higher than 20 dB are selected and outputted. Then, the selected pilot carriers P1 and P2 are used in the clock shift compensator 25 or the like to perform, for example, compensation for clock shift between the transmitter and the receiver.

Note that, although the structure of the receiver is described in the embodiment, it is also possible that a channel estimator is provided in the receiver or the transmitter, a pilot carrier selecting unit and a clock shift compensator are provided in the transmitter, CINR information is generated in the receiver or the transmitter on the basis of a reception signal in the receiver, and a pilot carrier is selected in the transmitter using the obtained CINR information to perform clock shift compensation.

In this way, according to the fourth embodiment, when a pilot carrier generated in a sub-carrier pair having adjacent two sub-carriers as a unit is used, it is possible to select and use a pilot carrier with a satisfactory characteristic according to a state of a channel between the transmitter and the receiver.

### Fifth Embodiment

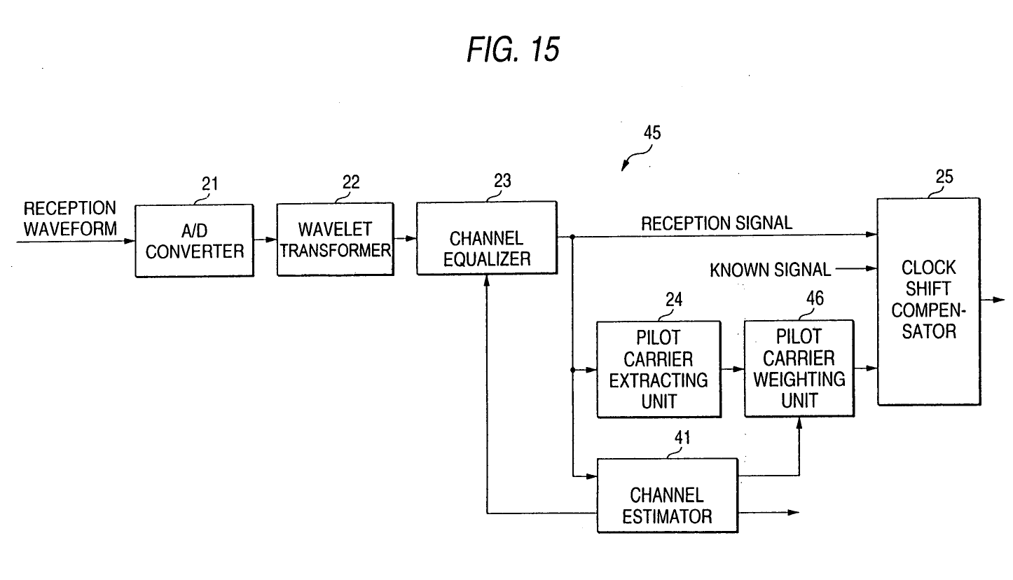

FIG. 15 is a block diagram showing a main structure of a receiver according to a fifth embodiment of the invention. The fifth embodiment is an example in which pilot carrier weighting means is provided when plural pilot carriers are used. Note that components same as those in as the first and the fourth embodiments are denoted by the identical reference numerals.

A receiver 45 in the fifth embodiment includes a channel estimator 41, which performs estimation of a channel characteristic, and a pilot carrier weighting unit 46, which performs weighting of a pilot carrier according to an output of the channel estimator 41, together with the A/D converter 21, the wavelet transformer 22, the channel equalizer 23, the pilot carrier extracting unit 24, and the clock shift compensator 25. The pilot carrier weighting unit has a function of pilot carrier weighting adder.

The pilot carrier weighting unit 46 determines, for plural pilot carriers extracted by the pilot carrier extracting unit 24, a weighting coefficient according to a value of CINR on the basis of CINR information outputted from the channel estimator 41 and outputs pilot carriers after weighting processing is applied. In a sub-carrier with large CINR and a satisfactory channel state, it is considered that accuracy of complex information obtained from a pilot carrier of this sub-carrier is high and the pilot carrier has a satisfactory characteristic. This embodiment is an example in which it is assumed that plural pilot carriers are fixedly set. Weighting for reception information of pilot carriers is performed such that weighting for pilot carriers of sub-carriers with large CINR is set large and weighting for pilot carriers of sub-carriers with small CINR is set small. For example, weighting only has to be performed in proportion to a value of CINR or weighting coefficients in plural stages only have to be set according to a value of CINR.

Plural pilot carriers are subjected to weighting processing by compounding the pilot carriers with a method such as selection compounding, maximum ratio compounding, or simple compounding on the basis of weighting coefficients of the respective pilot carriers. The pilot carriers weighted in this way are used to perform, for example, compensation for clock shift between the transmitter and the receiver in the clock shift compensator 25.

Note that, although the structure of the receiver is described in the embodiment, it is also possible that a channel estimator is provided in the receiver or the transmitter, a pilot carrier weighting unit and a clock shift compensator are provided in the transmitter, CINR information is generated in the receiver or the transmitter on the basis of a reception signal in the receiver, and pilot carriers are weighted in the transmitter using the obtained CINR information to perform clock shift compensation.

In this way, according to the fifth embodiment, when a pilot carrier generated in a sub-carrier pair having adjacent two sub-carriers as a unit is used, plural pilot carriers are weighted according to a state of a channel between the transmitter and the receiver, whereby it is possible to improve accuracy of complex information obtained from the pilot carriers.

### Sixth Embodiment

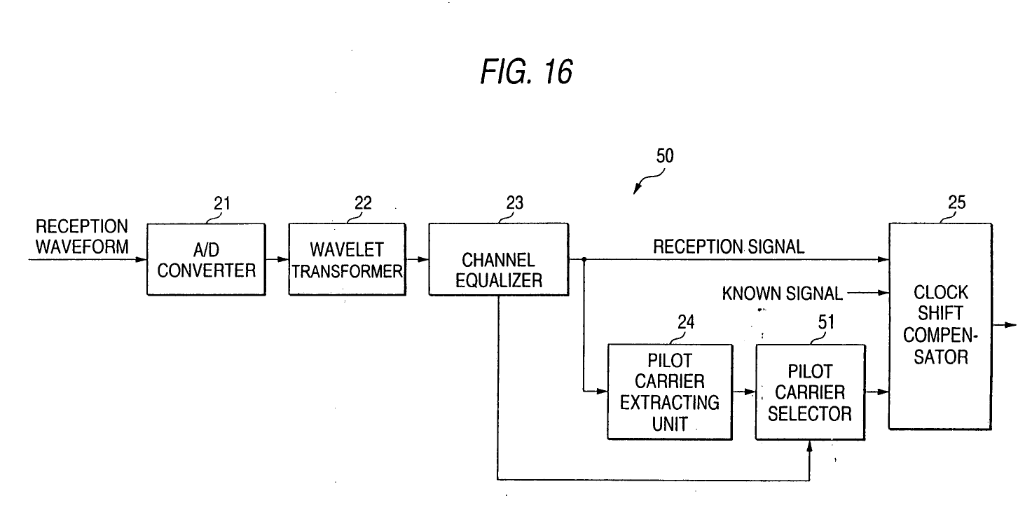

FIG. 16 is a block diagram showing a main structure of a receiver according to a sixth embodiment of the invention. The sixth embodiment is a second example in which pilot carrier selecting means is provided when plural pilot carriers are used. Note that components same as those in the first and the fourth embodiments are denoted by the identical reference numerals.

A receiver 50 in the sixth embodiment includes a pilot carrier selecting unit 51, which performs selection of a pilot carrier according to amplitude information obtained from the channel equalizer 23, together with the A/D converter 21, the wavelet transformer 22, the channel equalizer 23, the pilot carrier extracting unit 24, and the clock shift compensator 25.

The channel equalizer 23 exchanges predetermined signals between the transmitter and the receiver to detect a transmission characteristic in the channel and multiplies the transmission characteristic by an inverse characteristic of the transmission characteristic with a filter to thereby perform compensation such that the transmission characteristic is flat among sub-carriers. In this case, the channel equalizer 23 uses data for compensation in a preamble added before actual transmission data to determine a tap coefficient of the filter provide in the channel equalizer 23 according to amplitude information of the reception signal and compensate for the transmission characteristic.

The pilot carrier selecting unit 51 selects a pilot carrier to be used with a predetermined amplitude value as a threshold value among the plural pilot carriers extracted by the pilot carrier extracting unit 24 on the basis of amplitude information obtained from the tap coefficient of the filter in the channel equalizer 23. In a sub-carrier with an amplitude value equal to or higher than the threshold value and a satisfactory channel state, it is considered that accuracy of complex information obtained from a pilot carrier of this sub-carrier is high and the pilot carrier has a satisfactory characteristic. This embodiment is an example in which it is assumed that plural pilot carriers are fixedly set. A pilot carrier of a sub-carrier having amplitude information obtained by the channel equalizer equal to or higher than the threshold value is regarded as a pilot carrier appropriate for use as a reference signal and selected.

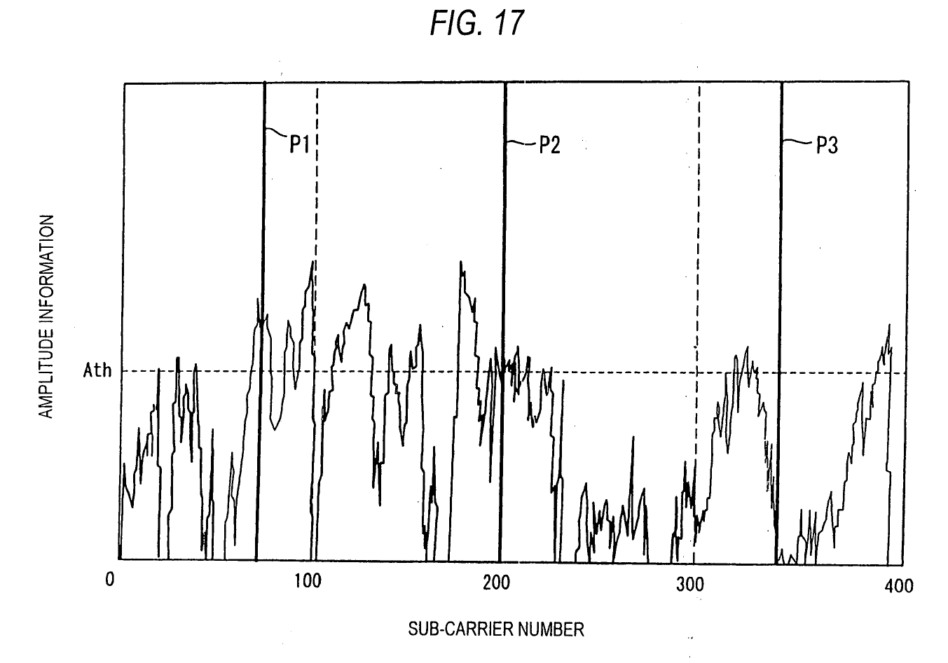

FIG. 17 is a characteristic chart showing an example of a relation between amplitude information for each sub-carrier obtained by the channel equalizer 23 and a pilot carrier. In FIG. 17, in sub-carriers from 1 to 390, three pilot carriers P1, P2, and P3 are fixedly set. In the pilot carrier selecting unit 51, for example, Ath is set as a threshold value, and the pilot carriers P1 and P2 with an amplitude value equal to or higher than Ath are selected and outputted. Then, the selected pilot carriers P1 and P2 are used in the clock shift compensator 25 or the like to perform, for example, compensation for clock shift between the transmitter and the receiver.

Note that, although the structure of the receiver is described in the embodiment, it is also possible that a channel equalizer is provided in the receiver or the transmitter, a pilot carrier selecting unit and a clock shift compensator are provided in the transmitter, equalization of a channel is performed in the receiver or the transmitter on the basis of a reception signal in the receiver, and a pilot carrier is selected in the transmitter using amplitude information obtained from this channel equalizer to perform clock shift compensation.

In this way, according to the sixth embodiment, when a pilot carrier generated in a sub-carrier pair having adjacent two sub-carriers as a unit is used, it is possible to select and use a pilot carrier with a satisfactory characteristic according to a state of a channel between the transmitter and the receiver.

### Seventh Embodiment

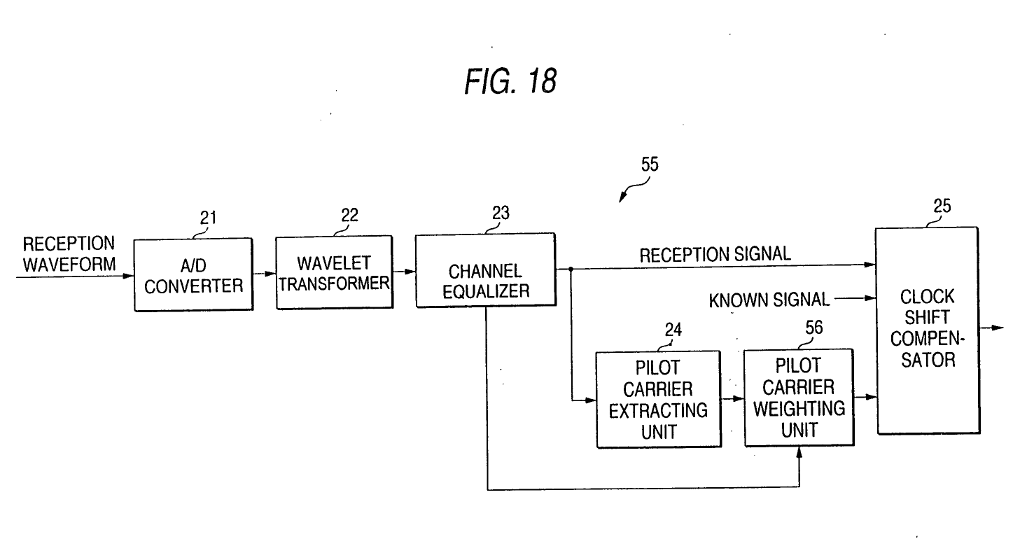

FIG. 18 is a block diagram showing a main structure of a receiver according to a seventh embodiment of the invention. The seventh embodiment is a second example in which pilot carrier weighting means is provided when plural pilot carriers are used. Note that components same as those in the first, the fifth, and the sixth embodiments are denoted by the identical reference numerals.

A receiver 55 in the seventh embodiment includes a pilot carrier weighting unit 56, which performs weighting for pilot carriers according to amplitude information obtained from the channel equalizer 23, together with the A/D converter 21, the wavelet transformer 22, the channel equalizer 23, the pilot carrier extracting unit 24, and the clock shift compensator 25.

The pilot carrier weighting unit 56 determines, for plural pilot carriers extracted by the pilot carrier extracting unit 24, a weighting coefficient according to an amplitude value on the basis of amplitude information obtained from a tap coefficient of a filter in the channel equalizer 23 and outputs pilot carriers after weighting processing is applied. In a sub-carrier with a large amplitude value and a satisfactory channel state, it is considered that accuracy of complex information obtained from a pilot carrier of this sub-carrier is high and the pilot carrier has a satisfactory characteristic. This embodiment is an example in which it is assumed that plural pilot carriers are fixedly set. Weighting for reception information of pilot carriers is performed such that weighting for pilot carriers of sub-carriers with a large amplitude value is set large and weighting for pilot carriers of sub-carriers with a small amplitude value is set small. For example, weighting only has to be performed in proportion to an amplitude value or weighting coefficients in plural stages only have to be set according to an amplitude value.

Plural pilot carriers are subjected to weighting processing by compounding the pilot carriers with a method such as selection compounding, maximum ratio compounding, or simple compounding on the basis of weighting coefficients of the respective pilot carriers. The pilot carriers weighted in this way are used to perform, for example, compensation for clock shift between the transmitter and the receiver in the clock shift compensator 25.

Note that, although the structure of the receiver is described in the embodiment, it is also possible that a channel equalizer is provided in the receiver or the transmitter, a pilot carrier weighting unit and a clock shift compensator are provided in the transmitter, equalization of a transmitting channel is performed in the receiver or the transmitter on the basis of a reception signal in the receiver, and pilot carriers are weighted in the transmitter using the amplitude information obtained from the channel equalizer to perform clock shift compensation.

In this way, according to the seventh embodiment, as in the sixth embodiment, when a pilot carrier generated in a sub-carrier pair having adjacent two sub-carriers as a unit is used, plural pilot carriers are weighted according to a state of a channel between the transmitter and the receiver, whereby it is possible to improve accuracy of complex information obtained from the pilot carriers.

### Eighth Embodiment

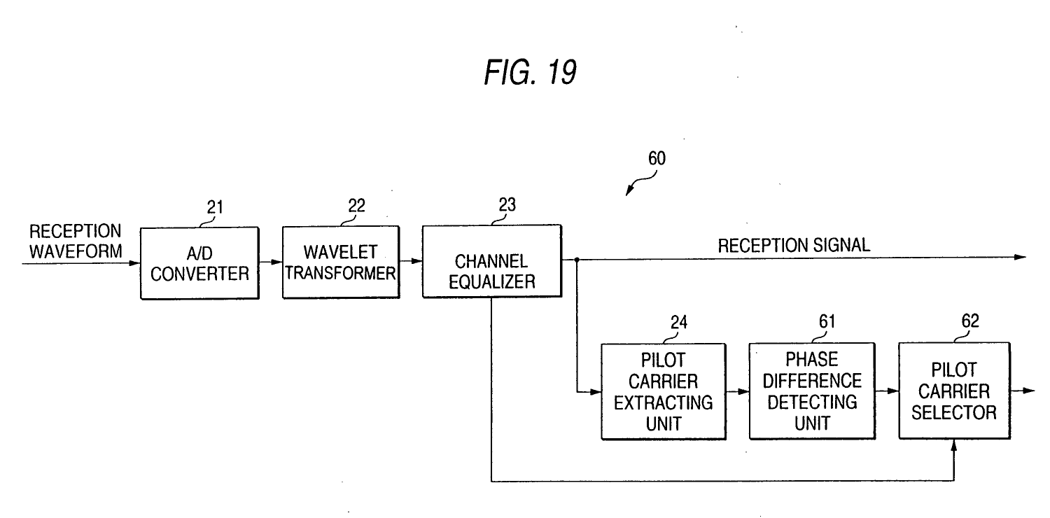

FIG. 19 is a block diagram showing a main structure of a receiver according to an eighth embodiment of the invention. The eighth embodiment is a third example in which pilot carrier selecting means is provided when plural pilot carriers are used. Note that components same as those in the first embodiment are denoted by the identical reference numerals.

A receiver 60 in the eighth embodiment includes a phase difference detecting unit 61, which detects a phase difference between a sub-carrier pair in plural pilot carriers, and a pilot carrier selecting unit 62, which performs selection of a pilot carrier according to an output of the phase difference detecting unit 61, together with the A/D converter 21, the wavelet transformer 22, the channel equalizer 23, and the pilot carrier extracting unit 24.

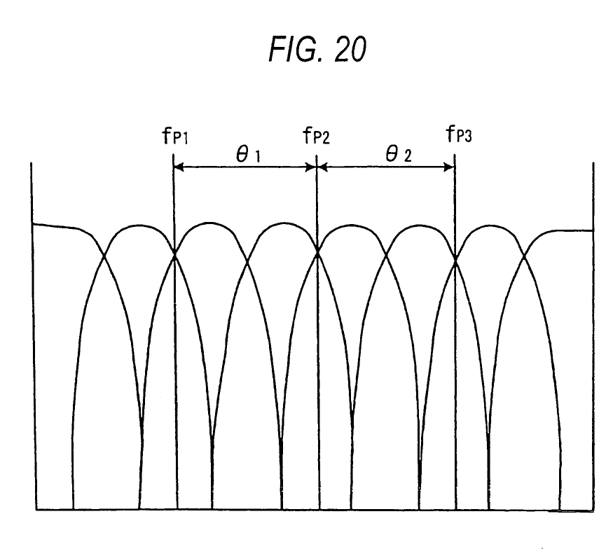

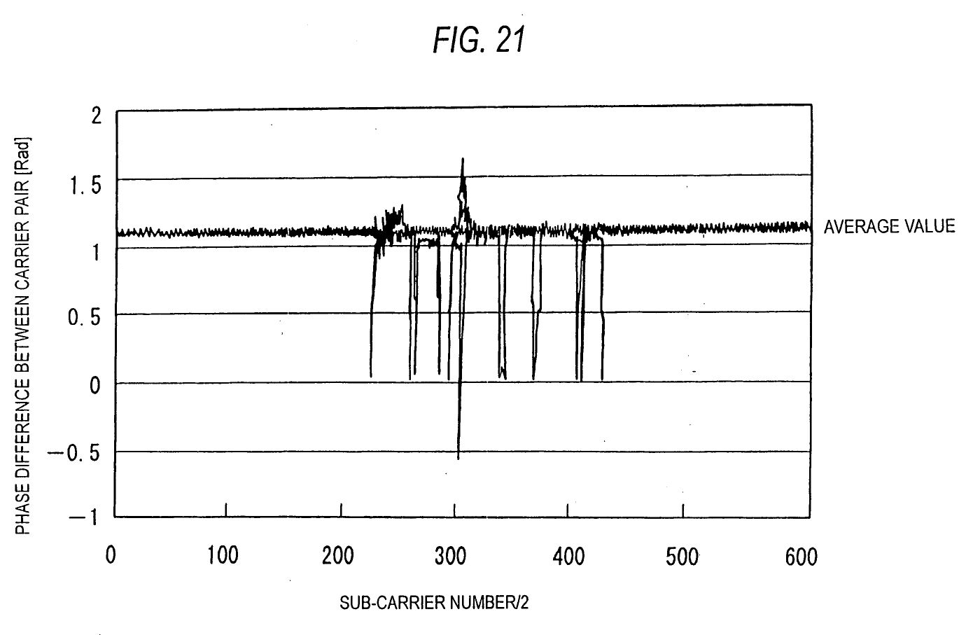

The phase difference detecting unit 61 is a unit that, concerning plural sine wave pilot carriers extracted by the pilot carrier extracting unit 24, detects a phase difference between a sub-carrier pair corresponding to the respective pilot carriers. FIG. 20 is a diagram schematically showing respective sub-carriers on a frequency axis. FIG. 21 is a characteristic chart showing an example of a phase difference between a sub-carrier pair. As shown in FIG. 20, when three pilot carriers of frequencies fp1, fp2, and fp3 are generated, phase differences θ1 and θ2 between a sub-carrier pair of these pilot carriers are detected. In FIG. 21, when a transmission characteristic of a channel is deteriorated and a phase of a transmission signal of a specific sub-carrier shifts, as a result, a phase difference between a sub-carrier pair for the sub-carrier deviates largely from an average value.

Thus, in this embodiment, the pilot carrier selecting unit 62 selects and outputs pilot carriers having a phase difference between a sub-carrier pair within a predetermined value with respect to the average value on the basis of an output of the phase difference detecting unit 61. In other words, pilot carriers of sub-carriers with a phase difference between a sub-carrier pair the predetermined value or more deviating from the average value are excluded and are not used. Then, the selected pilot carriers are used in the clock shift compensator 25 or the like to perform, for example, compensation for clock shift between the transmitter and the receiver.

Note that, although the structure of the receiver is described in the embodiment, it is also possible that a pilot carrier selecting unit and a clock shift compensator are provided in the transmitter and pilot carriers are selected in the transmitter using phase difference information between a sub-carrier pair detected in the receiver to perform clock shift compensation. In addition, a pilot carrier weighting unit may be provided instead of the pilot carrier selecting unit to weight pilot carriers to perform clock shift compensation.

In this way, according to the eighth embodiment, when a pilot carrier generated in a sub-carrier pair having adjacent two sub-carriers as a unit is used, it is possible to select and use a pilot carrier with a satisfactory characteristic according to a state of a channel between the transmitter and the receiver. It is also possible to improve accuracy of complex information obtained from the pilot carrier.

### Ninth Embodiment

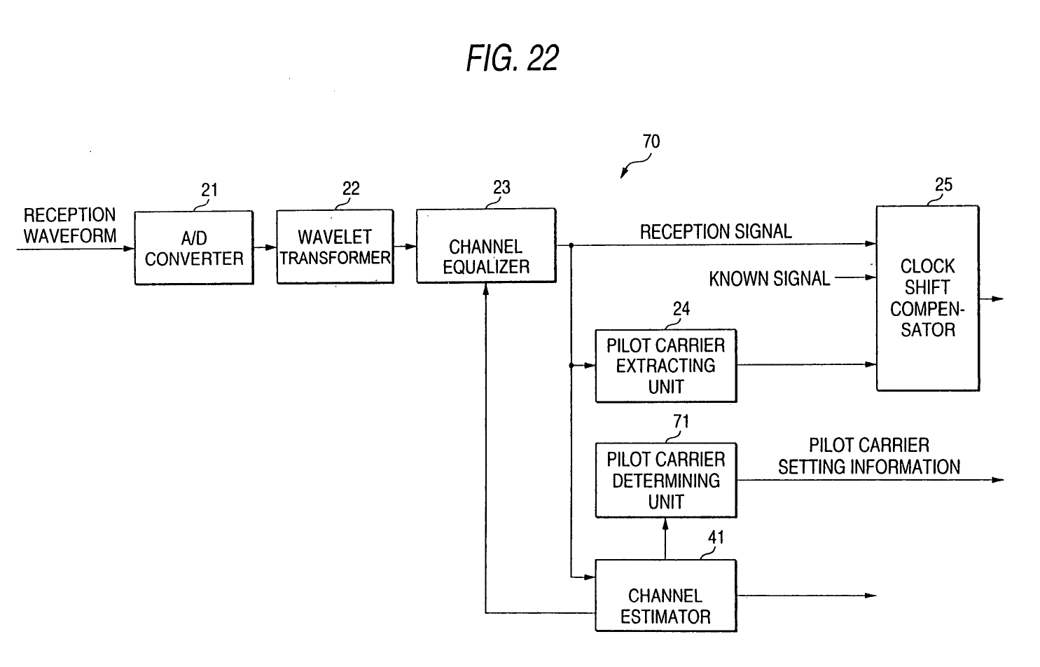

FIG. 22 is a block diagram showing a main structure of a receiver according to a ninth embodiment of the invention. The ninth embodiment is an example in which pilot carrier determining means is provided when plural pilot carriers are used. Note that components same as those in the first embodiment are denoted by the identical reference numerals.

A receiver 70 in the ninth embodiment includes the channel estimator 41, which estimates a channel characteristic, and a pilot carrier determining unit 71, which determines use of a pilot carrier according to an output of the channel estimator 41 and selects an arbitrary sub-carrier as a pilot carrier, together with the A/D converter 21, the wavelet transformer 22, the channel equalizer 23, the pilot carrier extracting unit 24, and the clock shift compensator 25. The pilot carrier determining unit has a function of pilot carrier determining means.

The pilot carrier determining unit 71 determines a sub-carrier uses ad a pilot carrier according to a value of CINR on the basis of CINR information outputted from the channel estimator 41 and outputs pilot carrier setting information. This pilot carrier setting information is transmitted to a transmitter and held in both the transmitter and the receiver. The transmitter sets a corresponding sub-carrier as a pilot carrier with reference to the pilot carrier setting information and transmits a transmission signal. In a sub-carrier with large CINR and a satisfactory channel state, it is considered that, if this sub-carrier is set as a pilot carrier, accuracy of complex information obtained from the pilot carrier is improved and the pilot carrier has a satisfactory characteristic. This embodiment is an example in which it is assumed that plural pilot carriers are fixedly set in arbitrary sub-carriers. A sub-carrier with large CINR is selected and set as a pilot carrier such that a pilot carrier with a satisfactory characteristic, which is appropriate as a reference signal, can be used.

Note that a modulation system at the time when a transmission signal is subjected to primary modulation with PAM or the like in the transmitter and the receiver is determined according to channel states of respective sub-carriers using CINR information obtained from the channel estimator 41. Thus, a communication quality for each sub-carrier is also indicated by primary modulation information set in the respective sub-carriers. Therefore, in selecting and setting a pilot carrier, a sub-carrier used as the pilot carrier may be determined according to primary modulation information, which is determined using CINR information, instead of the CINR information.

Amplitude information obtained from a tap coefficient of a filter in the channel equalizer 23 described in the sixth embodiment may be used to determined a pilot carrier according to an amplitude value of the amplitude information.

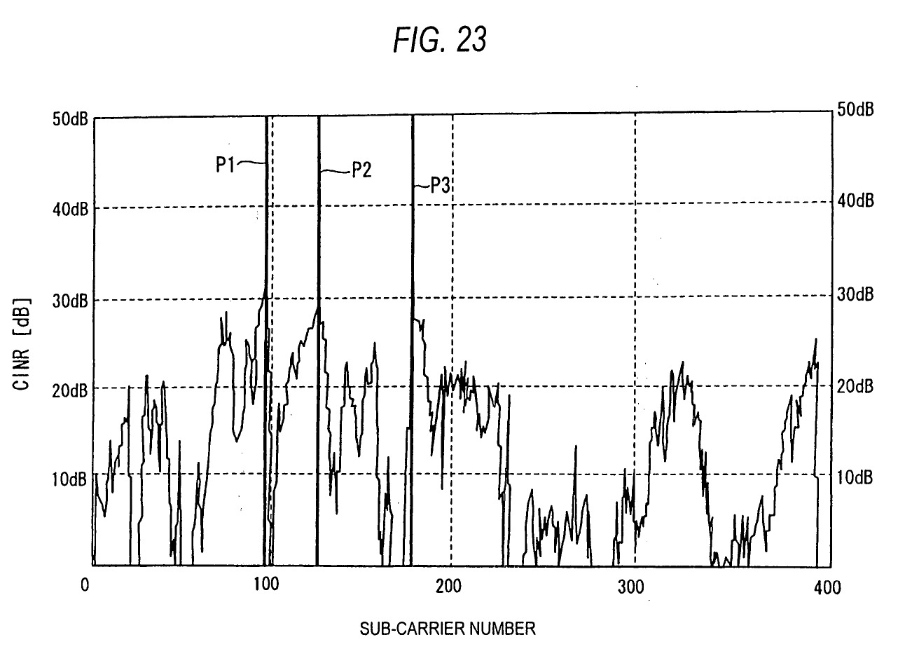

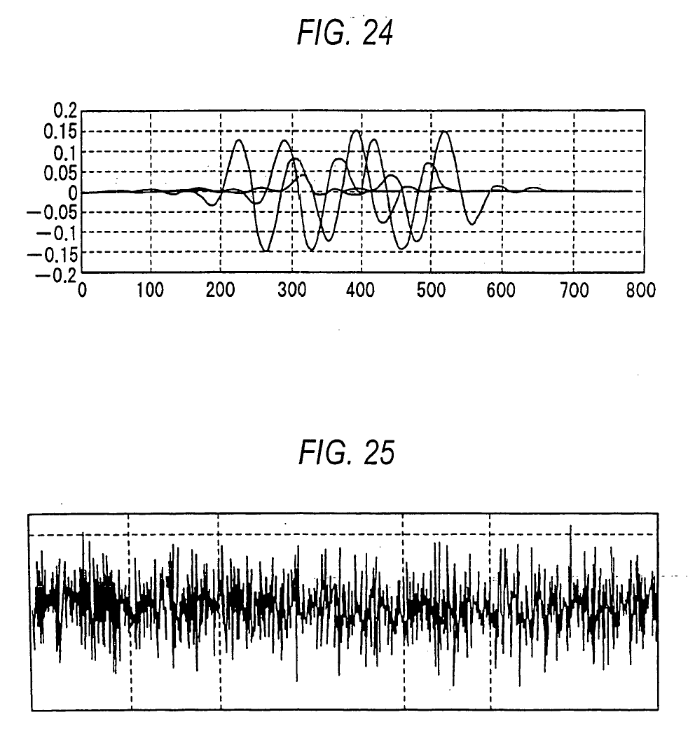

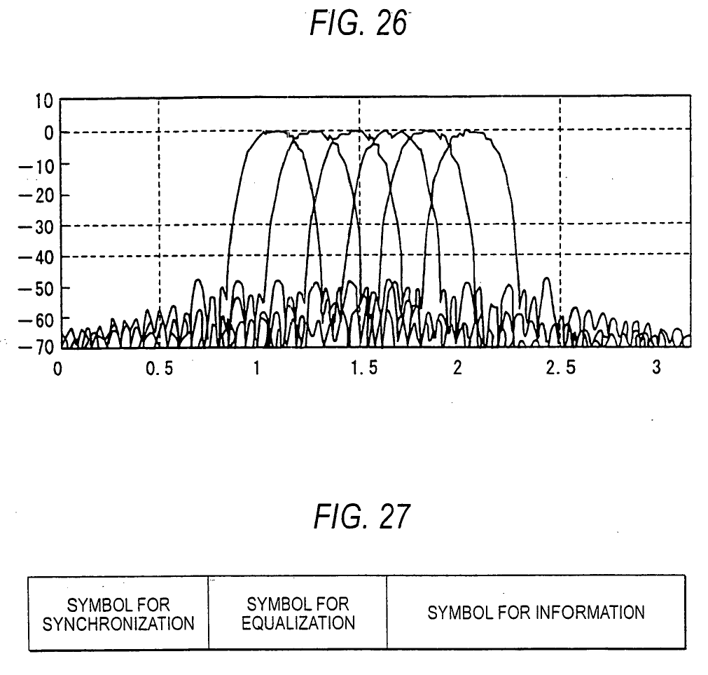

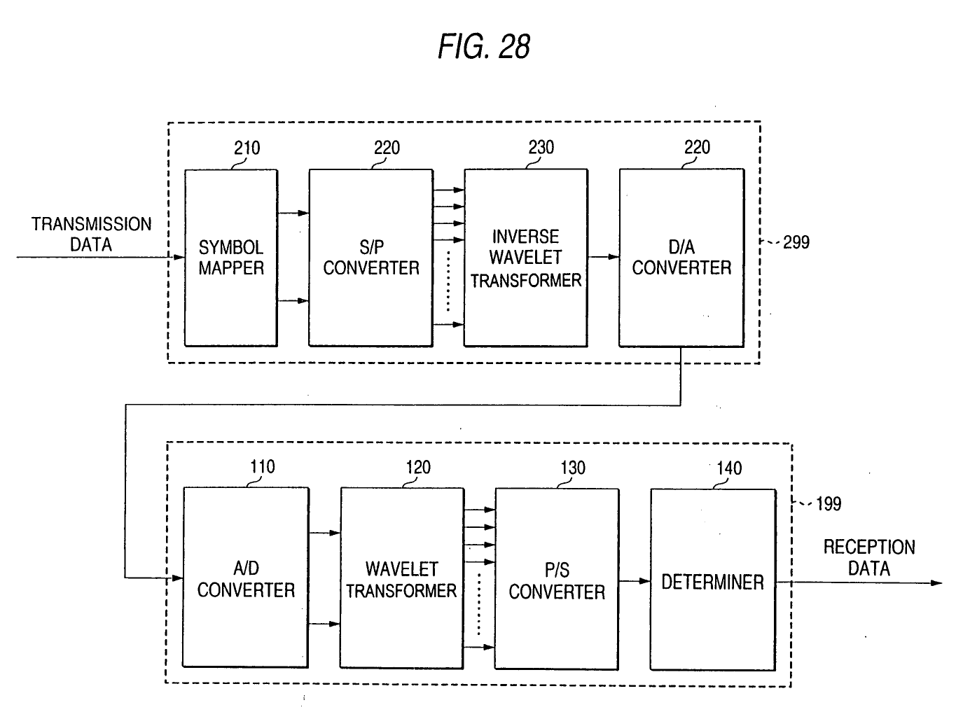

FIG. 23 is a characteristic chart showing an example of a relation between CINR information for each sub-carrier obtained from the channel estimator 41 and a pilot carrier. In FIG. 23, in sub-carriers from 1 to 390, three pilot carriers P1, P2, and P3 are selectively set. The pilot carrier determining unit 71 selects, for example, three sub-carrier pairs in an order of magnitude of CINR, sets the pilot carriers P1, P2, and P3 for these sub-carrier pairs, and outputs pilot carrier setting information. Then, this pilot carrier setting information is transmitted to the transmitter. The pilot carriers P1, P2, and P3 are generated in the selected sub-carrier pairs and transmitted. In the receiver, the pilot carriers P1, P2, and P3 are extracted from the pilot carrier extracting unit 24 and used in the clock shift compensator 25 or the like to perform, for example, compensation for clock shift between the transmitter and the receiver.

Note that, although the structure of the receiver is described in the embodiment, it is also possible that a pilot carrier determining unit is provided in the transmitter, CINR information is generated in the receiver or the transmitter on the basis of a reception signal in the receiver, a pilot carrier is determined in the transmitter using the obtained CINR information, and clock shift compensation is performed in the receiver or the transmitter.

In this way, according to the ninth embodiment, when a pilot carrier generated in a sub-carrier pair having adjacent two sub-carriers as a unit is used, it is possible to use a pilot carrier with a satisfactory characteristic by selecting a sub-carrier with a satisfactory channel state and set as a pilot carrier according to a state of a transmission carrier between the transmitter and the receiver. It is also possible to set the number, positions, intervals, and the like of pilot carriers adaptively according to a channel state.

### Tenth Embodiment

A tenth embodiment of the invention is a modification of the ninth embodiment. The pilot carrier determining unit 71 determines whether a pilot carrier is used and the number of use, intervals, and the like of pilot carriers.

The pilot carrier determining unit 71 determines use of a pilot carrier on the basis of CINR information outputted from the channel estimator 41 or primary modulation information of modulation system map data held by a memory. For example, the pilot carrier determining unit 71 refers to CINR information or primary modulation information in a frequency band in use and, when a value of CINR is large or a degree of modulation of primary modulation information is high (multi-value modulation), a state of a channel is satisfactory, and in particular, data transmission is possible without hindrance even if a pilot carrier is not used, does not use a pilot carrier and sets pilot carrier setting information to no use.

When a pilot carrier is used, the pilot carrier determining unit 71 refers to a maximum value or an average value in the CINR information or the primary modulation information and determines the number of pilot carriers to be used according to this value. Here, when a value of CINR is large or a degree of modulation of primary modulation information is high, the pilot carrier determining unit 71 reduces the number of pilot carriers in use. On the other hand, when a value of CINR is small or a degree of modulation of primary modulation information is low, the pilot carrier determining unit 71 increases the number of pilot carriers in use. Here, pilot carriers to be used are set in sub-carriers with a high value of the CINR information or the primary modulation information as described in the ninth embodiment. Alternatively, positions, intervals, and the like of pilot carriers may be set adaptively according to a channel state.

In this way, according to the tenth embodiment, when a pilot carrier generated in a sub-carrier pair having adjacent two sub-carriers as a unit is used, presence or absence of use and the number of pilot carriers in use are determined according to a state of a channel between the transmitter and the receiver, whereby it is possible to set the number of pilot carriers to a necessary minimum number and improve transmission efficiency in a frequency band in use.

Note that, in the respective embodiments, means for compensating for clock shift between the transmitter and the receiver may be implemented in the receiver or the transmitter or may be implemented in both the receiver and the transmitter. In addition, although the CINR information and the primary modulation information are used as parameters for selecting and determining a pilot carrier in the fourth to the tenth embodiments, a bit error rate on the reception side, a retransmission ratio of transmission data, a transmission rate (bps), and the like may be used.

This application is based upon and claims the benefit of priority of Japanese Patent Application No. 2004-121457 filed on Apr. 16, 2004, the contents of which are incorporated herein by reference in its entirety.

The invention has an advantage that it is possible to use a pilot carrier, which can handle complex information, in data transmission of the multi-carrier transmission system according to OFDM on a wavelet transformation basis for performing real coefficient wavelet transformation. The invention is useful for a communication apparatus, a communication method, and the like of the multi-carrier transmission system using the multi-carrier transmission method (the DWMC transmission method) for performing data transmission according to the digital modulation and demodulation processing using a real coefficient wavelet filter bank.

1. A communication apparatus of a multi-carrier transmission system that performs data transmission according to digital modulation and demodulation processing, comprising:
modulator which performs digital multi-carrier modulation processing for a transmission signal including a pilot carrier by use of a filter bank subjecting wavelet transformation, the pilot carrier being formed by giving continuous identical data to at least one of adjacent two sub-carriers; and
transmitter which transmits the transmission signal, which has been subjected the digital multi carrier modulation processing by said modulator.

2. A communication apparatus according to claim 1, wherein said modulator performs digital multi-carrier modulation processing for the transmission signal including the pilot carrier by use of a filter bank subjecting wavelet transformation, the pilot carrier being formed by giving continuous identical data to a sub-carrier pair including the adjacent two sub-carriers as a unit.

3. A communication apparatus according to claim 2, further comprising pilot carrier generator which generates the pilot carrier to give continuous identical data to the sub-carrier pair.

4. A communication apparatus according to claim 2, wherein one or more sub-carriers on both sides of the sub-carrier pair forming the pilot carrier are mask carriers that are not used for data transmission.

5. A communication apparatus according to claim 4, wherein the pilot carrier is formed by the sub-carrier pair next to the mask carrier set in advance.

6. A communication apparatus according to claim 2, wherein the pilot carrier is formed by giving continuous identical data in a continuous plurality of the sub-carrier pairs.

7. A communication apparatus according to claim 2, wherein plural pilot carriers are formed by giving continuous identical data to a continuous plurality of the sub-carrier pairs and a pilot carrier located in the center in an arrangement on a frequency axis among these plural pilot carriers is used.

8. A communication apparatus according to claim 2, wherein plural pilot carriers are formed by giving continuous identical data to a continuous or spaced apart plurality of the sub-carrier pairs and the plural pilot carriers are weighted and compounded to be used.

9. A communication apparatus according to claim 1, wherein said transmitter transmits the transmission signal through a power line.

10. A communication apparatus of a multi carrier transmission system that performs data transmission according to digital modulation and demodulation processing, comprising:
receiver which receives a transmission signal including a pilot carrier being formed by giving contiguous identical data to at least one of adjacent two sub-carriers; and
demodulator which performs digital multi carrier demodulation processing for the transmission signal received by said receiver with use of a filter bank subjecting wavelet transformation.

11. A communication apparatus according to claim 10, wherein said receiver receives the transmission signal including the pilot carrier being formed by giving continuous identical data to a sub-carrier pair including the adjacent two sub-carriers as a unit.

12. A communication apparatus according to claim 10, further comprising pilot carrier extractor that inputs a signal including the pilot carrier and obtains complex information according to this pilot carrier.

13. A communication apparatus according to claim 12, further comprising clock shift compensator which compensates for clock shift between a transmission side apparatus and a reception side apparatus using the complex information obtained from the pilot carrier.

14. A communication apparatus according to claim 11, wherein one or more sub-carriers on both sides of the sub-carrier pair forming the pilot carrier are mask carriers that are not used for data transmission.

15. A communication apparatus according to claim 14, wherein the pilot carrier is formed by the sub-carrier pair next to the mask carrier set in advance.

16. A communication apparatus according to claim 11, wherein the pilot carrier is formed by giving continuous identical data in a continuous plurality of the sub-carrier pairs.

17. A communication apparatus according to claim 11, wherein plural pilot carriers are formed by giving continuous identical data to a continuous plurality of the sub-carrier pairs and a pilot carrier located in the center in an arrangement on a frequency axis among these plural pilot carriers is used.

18. A communication apparatus according to claim 11, wherein plural pilot carriers are formed by giving continuous identical data to a continuous or spaced apart plurality of the sub-carrier pairs and the plural pilot carriers are weighted and compounded to be used.

19. A communication apparatus according to claim 10, wherein the demodulator includes two wavelet transformers that apply wavelet transformation using a filter bank to the transmission signal including the pilot carrier, output of the two wavelet transformers are in an orthogonal relation with each other, and a signal including complex information is outputted on the basis of the outputs of the two wavelet transformers.

20. A communication apparatus according to claim 10, wherein the demodulator includes one wavelet transformer that applies wavelet transformation using a filter bank to the transmission signal including the pilot carrier and a signal including complex information is outputted on the basis of an output of the one wavelet transformer.

21. A communication apparatus according to claim 11, further comprising pilot carrier selector that, when the plurality of the pilot carriers are fixedly set using a predetermined sub-carrier pair, selects a pilot carrier to be used from the plural pilot carriers using information indicating a channel state concerning respective sub-carriers that are obtained on the basis of a reception signal in a reception side apparatus.

22. A communication apparatus according to claim 21, wherein as the information indicting a channel state, at least one of CINR (carrier power to interference and noise power ratio) information obtained from a channel estimator that estimates a channel on the basis of a reception signal in the reception side apparatus, amplitude information obtained from a channel equalizer that equalizes a channel on the basis of a reception signal in the reception side apparatus, information on a phase difference between a sub-carrier pair obtained from a phase difference detector that detects a phase difference between sub-carriers of the transmission signal including the pilot carrier in the reception side apparatus, a bit error rate in the reception side apparatus, a data retransmission ratio of the transmission signal, and a transmission rate of the transmission signal is used.

23. A communication apparatus according to claim 11, further comprising pilot carrier weighting adder that, when the plurality of the pilot carriers are fixedly set using a predetermined sub-carrier pair, performs weighting at the time when the plural pilot carriers are used using information indicating a channel state concerning respective sub-carriers that are obtained on the basis of a reception signal in a reception side apparatus.

24. A communication apparatus according to claim 23, wherein as the information indicting a channel state, at least one of CINR (carrier power to interference and noise power ratio) information obtained from a channel estimator that estimates a channel on the basis of a reception signal in the reception side apparatus, amplitude information obtained from a channel equalizer that equalizes a channel on the basis of a reception signal in the reception side apparatus, information on a phase difference between a sub-carrier pair obtained from a phase difference detector that detects a phase difference between sub-carriers of the transmission signal including the pilot carrier in the reception side apparatus, a bit error rate in the reception side apparatus, a data retransmission ratio of the transmission signal, and a transmission rate of the transmission signal is used.

25. A communication apparatus according to claim 11, further comprising pilot carrier determining unit that, when the pilot carrier is selectively set using an arbitrary sub-carrier pair, selects and determines the sub-carrier pair used as the pilot carrier using information indicating a channel state concerning respective sub-carriers that are obtained on the basis of a reception signal in a reception side apparatus.

26. A communication apparatus according to claim 25, wherein the pilot carrier determining unit determines whether the pilot carrier is used according to the channel state.

27. A communication apparatus according to claim 26, wherein
the pilot carrier determining unit does not use the pilot carrier when the channel state is better than a predetermined value and selects a sub-carrier pair with a satisfactory channel state among the pilot carrier and determines the sub-carrier pair as a pilot carrier when the channel state is worse than the predetermined value.

28. A communication apparatus according to claim 26, wherein the pilot carrier determining unit determines the number of pilot carriers in use according to the channel state.

29. A communication apparatus according to claim 26, wherein when a plurality of the pilot carriers are selectively used, the pilot carrier determining unit determines an interval of the pilot carriers according to the channel state.

30. A communication apparatus according to claim 25, wherein as the information indicting a channel state, at least one of CINR (carrier power to interference and noise power ratio) information obtained from a channel estimator that estimates a channel on the basis of a reception signal in the reception side apparatus, primary modulation information of a transmission signal used in respective sub-carriers determined from a result of the estimation of a channel, amplitude information obtained from a channel equalizer that equalizes a channel on the basis of a reception signal in the reception side apparatus, information on a phase difference between a sub-carrier pair obtained from a phase difference detector that detects a phase difference between sub-carriers of the transmission signal including the pilot carrier in the reception side apparatus, a bit error rate in the reception side apparatus, a data retransmission ratio of the transmission signal, and a transmission rate of the transmission signal is used.

31. A communication apparatus according to claim 10, wherein said receiver receives the transmission signal through a power line.

32. A communication method of a multi-carrier transmission system that performs data transmission according to digital modulation and demodulation processing, the method comprising the steps of:
performing digital multi-carrier modulation processing for a transmission signal including a pilot carrier by use of a filter bank subjecting wavelet transformation, the pilot carrier being formed by giving continuous identical data to at least one of adjacent two sub-carriers; and
transmitting the transmission signal, which has been subjected the digital multi carrier modulation processing.

33. A communication method according to claim 32, wherein the transmission signal including the pilot carrier the pilot carrier being formed by giving continuous identical data to a sub-carrier pair including the adjacent two sub-carriers as a unit is subjected a digital multi-carrier modulation processing by use of a filter bank subjecting wavelet transformation.

34. A communication method of a multi carrier transmission system that performs data transmission according to digital modulation and demodulation processing, the method comprising:
receiving transmission signal including a pilot carrier being formed by giving contiguous identical data to at least one of adjacent two sub-carriers; and
performing digital multi carrier demodulation processing for the transmission signal received with use of a filter bank subjecting wavelet transformation.

35. A communication apparatus according to claim 34, wherein the transmission signal including the pilot carrier being formed by giving continuous identical data to a sub-carrier pair including the adjacent two sub-carriers as a unit is received.
